(19) United States
(12) Patent Application Publication
(10) Pub. No.: US 2010/0025869 A1
(43) Pub. Date: Feb. 4, 2010

(54) METHOD OF MANUFACTURING MOLDED ARTICLE FORMED WITH THERMOSETTING RESIN AND INJECTION MOLDING APPARATUS

(76) Inventors: Mitsunobu Suzuishi, Watari-gun (JP); Akihiro Saito, Watari-gun (JP); Hiroaki Usami, Watari-gun (JP); Hiroyuki Hirama, Watari-gun (JP); Ichiro Iibuchi, Watari-gun (JP); Toshiharu Igarashi, Watari-gun (JP); Masashi Yoshimura, Ibaraki-shi (JP)

Correspondence Address: BIRCH STEWART KOLASCH & BIRCH, PO BOX 747, FALLS CHURCH, VA, 22040-0747, US

(21) Appl. No.: 12/519,312

(22) PCT Filed: Sep. 14, 2007
(86) PCT No.: PCT/JP2007/067945

§ 371 Date: Jul. 23, 2009

(30) Foreign Application Priority Data
Feb. 20, 2007 (JP) 2007-039522
Mar. 28, 2007 (JP) 2007-084784

(51) Int. Cl. B29D 11/00; B29C 45/72; B29C 45/03

(52) U.S. Cl. 264/1.1; 264/328.1; 425/543

(57) ABSTRACT

There is provided a method of manufacturing a molded article formed with a thermosetting resin and an injection molding apparatus so that occurrence of blurs and containing of bubbles at the time of molding can be prevented. Provided is a method of manufacturing a molded article formed with a thermosetting resin by using a mold including: a cavity for molding a product part; a gate which commutes with the cavity to guide a liquid thermosetting resin into the cavity, thereby forming a gate part; a runner which commutes with the gate part to guide the liquid resin into the gate part, thereby forming a runner part; and an overflow catcher which commutes with the cavity to receive the liquid resin overflown from the cavity, thereby forming an overflow part, wherein the method includes: an injecting process of injecting the liquid resin from the runner through the gate to the cavity, until the overflow catcher is filled from the cavity; a hardening process of heating the liquid resin in the mold, thereby hardening the liquid resin; a demolding process of demolding a resin molded article having the runner part, the gate part, the product part, and the overflow part from the mold; and a cutting process of detaching the gate part and the overflow part from the product part of the demolded resin molded article.

### TECHNICAL FIELD

The present invention relates to a method of manufacturing a molded article formed with a thermosetting resin by using a liquid injection molding method and an injection molding apparatus.

### BACKGROUND ART

An injection molding method has been used as a general method of molding plastic products (or parts). In addition, in a case where a thermosetting resin is used for the injection molding, a liquid injection molding (LIM) method has been used. In the LIM method, a liquid thermosetting resin (liquid resin raw material; hereinafter, sometimes referred to as a liquid resin) is injected into a high temperature mold, and after that, thermosetting is performed. This method is a molding method where a liquid resin raw material is injected into a high temperature mold and, after that, thermosetting is performed.

In addition, the mold used for the injection molding is provided with a gas vent (gas extracting hole) which commutes with a cavity of the mold and an external portion of the mold, so that gas in the cavity of the mold cannot remain in the molded article when the resin is injected.

In a case where a resin raw material used for the injection molding has a relatively high viscosity, although a gas vent having a relatively large diameter is provided to sufficiently extract a gas, the resin raw material having a high viscosity cannot be flown into the gas vent. However, in the aforementioned liquid injection molding method, in a case where the resin raw material has a low viscosity, if a gas vent having a large diameter is provided, the resin raw material is flown into the gas vent. In this case, there is a problem in that blurs formed with the resin flown into the gas vent can easily occur in the molded article. Therefore, after the molding, the blurs needs to be removed. There is also a problem in that time and labor are required to remove the blurs.

On the other hand, if the gas vent is constructed to have a small diameter in order to prevent the occurrence of blurs, it is difficult to completely extract the gas, so that bubbles may be contained in the molded article. Therefore, strength and quality of the molded article may be lowered. In particular, in a case where the molded article (product part) is an optical device, there is a problem in that desired optical characteristics cannot be obtained from the optical device containing bubbles. As a related technique, a technique capable of easily changing a diameter of a gas extracting hole of a mold was disclosed (For example, refer to Patent Document 1) although the technique is not necessarily limited to the resin injection molding, but it is mainly used for metal casting.

Patent Document 1: Japanese Patent Application Laid-Open No. 2006-239722

### DISCLOSURE OF THE INVENTION

### Problem to be Solved by the Invention

However, in a liquid injection molding method using a thermosetting resin having a low viscosity at a room temperature, it is not easy to find a diameter of the gas vent which does not cause the occurrence of blurs and the occurrence of bubbles. Although a diameter of a gas vent can be easily adjusted, it is difficult to obtain a molded article having no blurs and containing no bubbles. In particular, an optical device having no desired optical characteristics influenced by the bubbles is not useful. Therefore, even in the occurrence of blurs, a molded article having no bubbles needs to be obtained.

In order to solve the aforementioned problems, the present invention is to provide a method of manufacturing a molded article formed with a thermosetting resin and an injection molding apparatus so that occurrence of blurs and containing of bubbles at the time of molding can be prevented.

### Means for Solving the Problem

In order to achieve the above object, according to a first aspect of the invention, there is provided a method of manufacturing a molded article formed with a thermosetting resin by using a mold including:

a cavity for molding a product part;

a gate which commutes with the cavity to guide a liquid thermosetting resin into the cavity, thereby forming a gate part;

a runner which commutes with the gate part to guide the liquid resin into the gate part, thereby forming a runner part; and

an overflow catcher which commutes with the cavity to receive the liquid resin overflown from the cavity, thereby forming an overflow part,

wherein the method includes:

an injecting process of injecting the liquid resin from the runner through the gate to the cavity, until the overflow catcher is filled from the cavity;

a hardening process of heating the liquid resin in the mold, thereby hardening the liquid resin;

a demolding process of demolding a resin molded article having the runner part, the gate part, the product part, and the overflow part from the mold; and

a cutting process of detaching the gate part and the overflow part from the product part of the demolded resin molded article.

In addition, according to a second aspect of the invention, there is provided a method of manufacturing a molded article formed with a thermosetting resin according to the first aspect, wherein the overflow catcher of the mold is disposed to be connected to a finally-filled position of the cavity where the liquid resin is finally filled or to a vicinity of the finally-filled position.

In addition, according to a third aspect of the invention, there is provided a method of manufacturing a molded article formed with a thermosetting resin according to the first or second aspect, wherein the thermosetting resin is a silicone resin.

In addition, according to a fourth aspect of the invention, there is provided a method of manufacturing a molded article formed with a thermosetting resin according to the third aspect, wherein the product part is a transparent optical device.

In addition, according to a fifth aspect of the invention, there is provided a method of manufacturing a molded article formed with a thermosetting resin according to the first aspect, wherein the injecting process is performed by using the mold so that a first cross section of a connection portion between the cavity and the overflow catcher is within +/−10% of a second cross section of a connection portion between the cavity and the gate, and the demolding process is performed to demold the resin molded article from the mold by striking a protrusion pin (ejector pin) disposed to the mold on the runner part and the overflow part of the resin molded article.

In addition, according to a sixth aspect of the invention, there is provided a method of manufacturing a molded article formed with a thermosetting resin according to the fifth aspect, wherein the demolding process is performed to demold the resin molded article from the mold by striking the protrusion pin on the resin molded article while spraying a gas against the resin molded article for cooling.

In addition, according to a seventh aspect of the invention, there is provided a method of manufacturing a molded article formed with a thermosetting resin according to the first aspect, wherein a cavity insert having a forming plane for forming a whole of the resin molded article in the mold is disposed, and the demolding process is performed to demold the resin molded article from the cavity insert by vibrating the cavity insert with an ultrasonic vibrator during a mold opening operation and/or after the mold opening.

In addition, according to an eighth aspect of the invention, there is provided a method of manufacturing a molded article formed with a thermosetting resin according to the seventh aspect, wherein the forming plane which is disposed to the cavity insert to form the whole of the resin molded article is constructed as a fixed plane which is not moved at least in the demolding process.

In addition, according to a ninth aspect of the invention, there is provided a method of manufacturing a molded article formed with a thermosetting resin according to the seventh or eighth aspect, wherein the cavity insert is fitted into a mold plate through an elastic member, the elastic member has a function as a sealing member for sustaining sealing of a resin molded article forming portion, and vacuum molding is performed in the injecting process.

In addition, according to a tenth aspect of the invention, there is provided a method of manufacturing a molded article formed with a thermosetting resin according to the seventh and eighth aspect, wherein the injecting process is performed by using the mold where a first cross section of a connection portion between the cavity and the overflow catcher is equal to or less than a second cross section of a connection portion between the cavity and the gate.

In addition, according to an eleventh aspect of the invention, there is provided a method of manufacturing a molded article formed with a thermosetting resin according to the tenth aspect, wherein the injecting process is performed by using the mold where the first cross section is 0.2 times to 1.0 time of the second cross section.

In addition, according to a twelfth aspect of the invention, there is provided a method of manufacturing a molded article formed with a thermosetting resin according to the tenth aspect, wherein the injecting process is performed by using the mold where the first cross section is 0.5 times to 1.0 time of the second cross section.

In addition, according to a thirteenth aspect of the invention, there is provided a method of manufacturing a molded article formed with a thermosetting resin according to the seventh aspect, wherein the demolding process is performed to demold the resin molded article from the cavity insert by vibrating the cavity insert with the ultrasonic vibrator while spraying a gas against the resin molded article for cooling, during a mold opening operation and/or after the mold opening.

In addition, according to a fourteenth aspect of the invention, there is provided an injection molding apparatus which is used for forming a molded article which is formed with a thermosetting resin through a liquid injection molding method, having a mold including:

a cavity for molding a product part;

a gate which commutes with the cavity to guide a liquid thermosetting resin into the cavity, thereby forming a gate part;

runner which commutes with the gate part to guide the liquid resin into the gate part, thereby forming a runner part; and

an overflow catcher which commutes with the cavity to receive the liquid resin overflown from the cavity, thereby forming an overflow part,

wherein a protrusion pin (ejector pin) is disposed to be struck on the runner part and the overflow part so as to demold a resin molded article having the runner part, the gate part, the product part, and the overflow part from the mold,

a first cross section of a connection portion between the cavity and the overflow catcher is within +/−10% of a second cross section of a connection portion between the cavity and the gate.

In addition, according to a fifteenth aspect of the invention, there is provided an injection molding apparatus which is used for forming a molded article which is formed with a thermosetting resin through a liquid injection molding method, having a mold including:

a cavity for molding a product part;

a gate which commutes with the cavity to guide a liquid thermosetting resin into the cavity, thereby forming a gate part;

a runner which commutes with the gate part to guide the liquid resin into the gate part, thereby forming a runner part; and

an overflow catcher which commutes with the cavity to receive the liquid resin overflown from the cavity, thereby forming an overflow part,

wherein a cavity insert having a forming plane for forming a whole of the resin molded article in the mold is disposed and an ultrasonic vibrator for vibrating the cavity insert is disposed, so as to demold a resin molded article having the runner part, the gate part, the product part, and the overflow part from the mold.

In addition, according to a sixteenth aspect of the invention, there is provided an injection molding apparatus according to the fifteenth aspect, wherein the forming plane which is disposed to the cavity insert to form the whole of the resin molded article is constructed as a fixed plane which is not moved at least in the demolding process.

In addition, according to a seventeenth aspect of the invention, there is provided an injection molding apparatus according to the fifteenth or sixteenth aspect, wherein the cavity insert is fitted into a mold plate through an elastic member, and the elastic member has a function as a sealing member for sustaining sealing of a resin molded article forming portion when vacuum molding is performed in the injecting process.

In addition, according to an eighteenth aspect of the invention, there is provided an injection molding apparatus according to the fifteenth or sixteenth aspect, wherein the cavity insert is provided with a flange portion so that position fixing is performed by interposing the flange portion.

In addition, according to a nineteenth aspect of the invention, there is provided an injection molding apparatus according to the eighteenth aspect, wherein an interstice is provided to an outer circumference of the flange portion of the cavity insert.

In addition, according to a twentieth aspect of the invention, there is provided an injection molding apparatus according to the fifteenth or sixteenth aspect, wherein an injecting process is performed by using the mold where a first cross section of a connection portion between the cavity and the overflow catcher is equal to or less than a second cross section of a connection portion between the cavity and the gate.

In addition, according to a twenty-first aspect of the invention, there is provided an injection molding apparatus according to the twentieth aspect, wherein the injecting process is performed by using the mold where the first cross section is 0.2 times to 1.0 time of the second cross section.

In addition, according to a twenty-second aspect of the invention, there is provided an injection molding apparatus according to the twentieth aspect, wherein the injecting process is performed by using the mold where the first cross section is 0.5 times to 1.0 time of the second cross section.

In addition, according to a twenty-third aspect of the invention, there is provided an injection molding apparatus according to any one of the fourteenth to sixteenth aspects, wherein gas spraying means for spraying a gas against the resin molded article during a mold opening operation and/or after the mold opening is disposed.

In addition, according to a twenty-fourth aspect of the invention, there is provided an injection molding apparatus according to the twenty-third aspect, wherein an extracting unit for extracting the resin molded article from the mold is further provided, and wherein the gas spraying means is disposed to an extracting chuck assembly of the extracting unit.

According to the first, fourteenth, and fifteenth aspects of the invention, in a case where a molded article is formed by using a liquid injection molding method (LIM method), if a liquid resin is injected into the cavity through the runner and the gate of the mold, the cavity is firstly filled with the resin, and after that, the liquid resin is flown into the overflow catcher. At this time, a gas in the cavity together with the liquid resin is pushed out into the overflow catcher. Next, the gas pushed out into the overflow catcher is extracted through the gas vent which commutes with the overflow catcher. In this case, the gas vent which extracts the gas from the mold is connected to the overflow catcher. In case of vacuum molding where vacuum suction is performed, the gas vent can be omitted.

As described above, in the present invention, the mold is used, and the gas in the cavity together with the liquid resin is pushed out into the overflow catcher, so that no gas remains in the cavity. Therefore, no bubbles are contained in the product part of the resin molded article. In addition, after the resin molded article is extracted from mold, if necessarily molded portions (runner part, gate part, overflow part, and the like) formed by hardening the resin injected in the gate, the overflow, and the like are removed from the resin molded article, it is possible to obtain a desired plastic product (product part) containing no bubbles. At this time, as described above, although the overflow part is attached to the resin molded article that are just extracted from the mold, since the overflow parts have the same shape over all the resin molded articles, the overflow part can be mechanically cut by the same method as that of the gate part. Therefore, a blur removing process or a bubble inspection process need not be individually performed over all the resin molded articles, so that it is possible to improve productivity.

In addition, according to the fourteenth aspect of the invention, since the product part can be pushed out by striking two portions of the product part of the resin molded article with the protrusion pin, the resin molded article can be demolded from the mold without occurrence of any flaw in the product part. In addition, since the first cross section of a connection portion between the cavity and the overflow part is substantially equal to second cross section of a connection portion between the cavity and the gate, it is possible to prevent destruction caused from concentration of a stress on one of the gate part and the overflow part.

In addition, according to the fifteenth aspect of the invention, instead of performing protrusion by the protrusion pin, the resin molded article is demolded from the cavity insert by vibrating the cavity insert with the ultrasonic vibrator during the mold opening operation and/or after the mold opening, so that the resin molded article can be smoothly and simply demolded from the cavity insert of the mold without destruction of the resin molded article. In addition, a structure of the mold can be simplified by omitting the protrusion pin, and there is no need to dispose an abutting portion to the resin molded article, to which the protrusion pin is abutted. In addition, since there is no need to delay a protrusion speed in consideration of the destruction of the gate part or the like similarly to the case of the protrusion by the protrusion pin, a working time for demolding can be greatly reduced, so that it is possible to improve work efficiency.

According to the second aspect of the invention, since the overflow catcher is connected to a finally-filled position of the cavity where the liquid resin is finally filled or to a vicinity of the finally-filled position, a gas in the cavity can be easily extracted. That is, in the present invention, as described above, the gas in the cavity is pushed out into the overflow catcher by the liquid resin injected into the cavity, so that the gas in the cavity can be extracted. Therefore, since the overflow catcher is disposed in the vicinity of the finally-filled position of the liquid resin in the cavity, the gas in the cavity can be surely extracted.

According to the third aspect of the invention, since a silicone resin has a low viscosity and a high fluidity, blurs can easily occur, and it is difficult to demold the resin molded article from the mold. Therefore, the present invention is particularly useful for injection molding of the silicone resin.

According to the fourth aspect of the invention, the product part of the resin molded article is a transparent optical device. In many cases, a product part for a transparent optical device such as an optical lens is small, and a plurality of the product parts are formed in one resin molded article. Therefore, it is difficult to demold the resin molded article from the mold. However, in the present invention, since the resin molded article can be smoothly demolded, occurrence of partial remnants of the resin molded article in the mold can be suppressed. In addition, since a transparent optical device containing no bubbles can be constructed, it is possible to surely obtain desired optical characteristics.

According to the fifth aspect of the invention, since the product part can be pushed out by striking two portions of the product part of the resin molded article with the protrusion pin, the resin molded article can be demolded from the mold without occurrence of any flaw in the product part. In addition, since the first cross section of a connection portion between the cavity and the overflow part is substantially equal to second cross section of a connection portion between the cavity and the gate, it is possible to prevent destruction caused from a concentration of a stress on one of the gate part and the overflow part.

According to the sixth aspect of the invention, a gas is sprayed to the resin molded article to cool (quench) the resin molded article, so that resin molded article is rapidly shrunk. Therefore, the resin molded article can be easily demolded from the mold. In this state, since the resin molded article is protruded from the mold, the resin molded article can be smoothly demolded from the mold. In this case, it is preferable that the gas is sprayed so that the gas can be further infiltrated into an interstice between the resin molded article and the mold, which is formed due to a shrinkage of the resin molded article caused from the gas sprayed. As a result, the resin molded article is also cooled by the gas sprayed from the interstice, so that the resin molded article can be efficiently cooled.

According to the seventh, eighth, and sixteenth aspects of the invention, instead of performing protrusion by the protrusion pin, the resin molded article is demolded from the cavity insert by vibrating the cavity insert with the ultrasonic vibrator during the mold opening operation and/or after the mold opening, so that the resin molded article can be smoothly and simply demolded from the cavity insert of the mold without destruction of the resin molded article. In addition, a structure of the mold can be simplified by omitting the protrusion pin, and there is no need to dispose an abutting portion to the resin molded article, to which the protrusion pin is abutted. In addition, since there is no need to delay a protrusion speed in consideration of the destruction of the gate part or the like similarly to the case of the protrusion by the protrusion pin, a working time for demolding can be greatly reduced, so that it is possible to improve work efficiency.

In addition, according to the ninth and seventeenth aspects of the invention, since the cavity insert is fitted into the mold plate through an elastic member, an interstice can be formed between the cavity insert and the mold plate. Therefore, an accurate position of the cavity insert can be ensured when the resin molded article is formed by injection and hardening of the resin, and the cavity insert can be ultrasonically vibrated at the time of the demolding. In addition, since the elastic member also has a function as a sealing member for sustaining sealing of a resin molded article forming portion at the time of the vacuum molding, it is possible to simplify a structure of the mold.

According to the tenth and twentieth aspects of the invention, since the first cross section of a connection portion between the cavity and the overflow catcher is equal to or less than the second cross section of a connection portion between the cavity and the gate, a first cut plane formed by cutting the overflow part of an accomplished product can be designed to be equal to or less than a second cut plane formed by cutting the gate part.

In a case where a post process such as a cutting process or a polishing process is not performed on the product part (molded article main body) where the gate part and the overflow part are cut off, the second cross section of a connection portion between the cavity and the gate is designed to have a sufficient area so that the liquid resin can be smoothly flown into the cavity at the time of the injection molding, and the second cross section is also designed to have an area which is not larger than an area necessary for preventing the influence on a shape of the product part.

On the other hand, in the first cross section of a connection portion between the cavity and the overflow catcher, it is preferable that the liquid resin which is likely to contain bubbles is smoothly overflown into the overflow catcher. In addition, since the liquid resin in the cavity is not guided out, the first cross section is preferably equal to or less than the second cross section. More preferably, the first cross section is further smaller in order to prevent occurrence of influence to a shape of the product part.

Namely, conventionally, if bubbles are completely removed, the aforementioned cut plane of the gate part and the blurs caused from the gas vent remain in the product part. However, in the present invention, the cut plane of the gate part and the cut plane of the overflow part remain in the product part. In addition, if a post process is not performed after the cutting, the cut plane of the gate part and the cut plane of the overflow part remain in the molded article which is to be a product, and thus, there is a limitation to the design of shape of the product part. Therefore, a degree of freedom in the design of shape of the product part is reduced in proportion to an increase in the cut plane of the overflow part. Accordingly, if the cut plane of the overflow part is equal to or less than the cut plane of the gate part, the limitation to the design can be reduced.

According to the eleventh and twenty-first aspects of the invention, in the mold, since the first cross section is equal to or more than 0.2 times of the second cross section, a liquid resin containing bubbles can be expelled into the overflow catcher. Namely, if the first cross section is less than 0.2 times of the second cross section, bubbles which become large may not be expelled from the cavity into the overflow catcher. Therefore, since the first cross section is designed to be equal to or more than 0.2 times of the second cross section, it is possible prevent the bubbles from remaining in the cavity.

In this case, as described above, the second cross section in the gate is designed to have a sufficient area so that the liquid resin can be smoothly flown into the cavity at the time of injection molding, and the second cross section is also designed to have an area which is not larger than an area necessary for preventing the influence on a shape of the product part. Since the first cross section is defined based on the second cross section, it is possible to adapt to a volume, shape, or the like of the cavity. That is, if the volume of the cavity is increased, a diameter of the gate may be increased, and the bubbles may occur with a high probability. Since the first cross section in the overflow catcher is defined based on the second cross section in the gate, it is possible to determine whether or not the bubbles are smoothly moved from the cavity to the overflow catcher.

In addition, as described above, since the second cross section in the gate is designed to have a sufficient area so that the liquid resin can be smoothly flown into the cavity at the time of the injection molding, the first cross section in the overflow catcher needs not to have an area which is equal to or larger than the second cross section in order to smoothly flow the liquid resin into the cavity. In addition, as described above, in the design of the shape of the product part, since it is preferable that the first cross section is small, there is a need in that the first cross section is equal to or less than 1.0 time of the second cross section.

According to the twelfth and twenty-second aspects of the invention, in the mold, since the first cross section is equal to or more than 0.5 times of second cross section, a liquid resin containing bubbles can be surely expelled into the overflow catcher, so that it is possible to improve yields of products.

As described above, in the mold, if the first cross section is equal to or more than 0.2 times of the second cross section, the liquid resin containing bubbles can be expelled into the overflow catcher. However, it several conditions are bad, bubbles may remain in the cavity. Therefore, the first cross section is designed to be equal to or more than 0.5 times of the second cross section. Accordingly, even in the above case, the bubble can be surely expelled from the cavity, so that it is possible to improve the yields.

According to the thirteenth and twenty-third aspects of the invention, a gas is sprayed to the resin molded article to cool (quench) the resin molded article, so that resin molded article is rapidly shrunk. Therefore, the resin molded article can be easily demolded from the mold or the cavity insert. In this state, since the resin molded article is protruded from the mold, or since the cavity insert is vibrated by the ultrasonic vibrator, the resin molded article can be smoothly demolded from the mold or the cavity insert. In this case, it is preferable that the gas is sprayed so that the gas can be further infiltrated into an interstice between the resin molded article and the mold or the cavity insert, which is formed due to a shrinkage of the resin molded article caused from the gas sprayed. As a result, the resin molded article is cooled by the gas sprayed from the interstice, so that the resin molded article can be efficiently cooled.

According to the eighteenth aspect of the invention, the cavity insert is provided the flange portion, and position fixing is performed by interposing the flange portion, so that it is possible to simplify a structure of the mold. When a spacer is provided, the position fixing can be accurately performed.

According to the nineteenth aspect of the invention, since an interstice is provided to an outer circumference of the flange portion of the cavity insert, the flange portion can be ultrasonically vibrated in the outer circumference.

According to the twenty-fourth aspect of the invention, a gas is sprayed to the resin molded article by the gas spraying means disposed to the extracting chuck assembly of the extracting unit to cool (quench) the resin molded article, so that the resin molded article is rapidly shrunk. Therefore, the resin molded article can be easily demolded from the mold or the cavity insert. In this state, since the resin molded article is protruded from the mold, or since the cavity insert is vibrated by the ultrasonic vibrator, the resin molded article can be smoothly demolded from the mold or the cavity insert. In addition, since the gas spraying means is disposed to the extracting unit, it is possible to simplify a structure. Since a gas can be sprayed out from a vicinity of the resin molded article, it is possible to effectively spray the gas.

### EFFECT OF THE INVENTION

According to the present invention, an overflow catcher is disposed to commute with a cavity where a product part of a resin molded article is molded, and, at the time of injection molding, a gas in the cavity together with a liquid resin is pushed out into the overflow catcher, so that bubbles cannot be contained in the product part. Therefore, according to the present invention, it is possible to obtain a product part formed with a thermosetting resin having a very high quality.

### BRIEF DESCRIPTION OF THE DRAWINGS

FIG. 1 is a plan view illustrating a resin molded article according to a first embodiment of the present invention.

FIG. 2 is a side view illustrating the resin molded article where a portion there is illustrated to be notched, according to the embodiment.

FIG. 3 is a side view illustrating a mold unit of an injection molding apparatus according to the embodiment.

FIG. 4 is a view taken along arrow line A-A of FIG. 3 according to the embodiment.

FIG. 5 is a front view illustrating an extracting chuck assembly of an extracting unit according to the embodiment.

FIG. 6 is a side view illustrating the extracting chuck assembly of the extracting unit according to the embodiment.

FIG. 7 is a cross sectional view illustrating principals of the mold according to the embodiment.

FIG. 8 is schematic cross sectional view illustrating a mold of an injection molding apparatus according to a second embodiment of the present invention.

FIG. 9 is an enlarged view illustrating principal components of FIG. 8 according to the embodiment.

FIG. 10 is a schematic cross sectional view illustrating a fixed side mold of the mold according to the embodiment.

FIG. 11 is a schematic cross sectional view illustrating a movable side mold of the mold according to the embodiment.

FIG. 12 is a detailed enlarged view illustrating principal components of FIG. 11 according to the embodiment.

FIG. 13 is a cross sectional view diagrammatically illustrating a mold according to a third embodiment of the present invention.

FIG. 14(a) is a cross sectional view taken along line A-A of FIG. 13, and FIG. 14 (b) is a cross sectional view taken along line B-B of FIG. 13 according to the embodiment.

FIG. 15 is a plan view diagrammatically illustrating a movable side mold of the mold according to the embodiment.

FIG. 16(a) is a plan view illustrating a resin molded article according to the embodiment, and FIG. 16(b) is a plan view illustrating a product part (optical device) according to the embodiment.

FIG. 17 is a view illustrating a product part (optical device) according to a modified example, where FIG. 17(a) is a plan view, FIG. 17(b) is a front view, FIG. 17(c) is a left side view, FIG. 17(d) is a right side view, FIG. 17(e) is a rear view, FIG. 17(f) is a bottom view, FIG. 17(g) is a cross sectional view taken along line A-A of FIG. 17(a), and FIG. 17(h) is a cross sectional view taken along line B-B of FIG. 17(a).

### REFERENCE NUMERALS

1: resin molded article
2: product part (transparent optical device)
3: gate part
4: overflow part
5: runner part
10: mold
12: movable side mold (mold)
21: air spraying nozzle (gas spraying means)
41: extracting unit
44: extracting chuck assembly
46: air spraying hole (gas spraying means)
55: runner
56: gate
70: cavity
71: overflow catcher
110: mold
112: movable side mold (mold)
114: forming plane
115: runner
116: gate
117: cavity
118: overflow catcher
137: cavity insert
156: O-ring (elastic member, sealing member)
158: flange portion
164: interstice
171: ultrasonic vibrator
201: mold
202: movable side mold (cavity insert, mold)
205: runner
206: gate
209: forming plane
215: cavity
216: overflow catcher
220: resin molded article
221: overflow part
222: product part (transparent optical device)
223: gate part
224: runner part
240: product part (optical device)
S1: first cross section
S2: second cut plane

### BEST MODE FOR CARRYING OUT THE INVENTION

Hereinafter, embodiments of the present invention will be described with reference to the accompanying drawings.

### First Embodiment

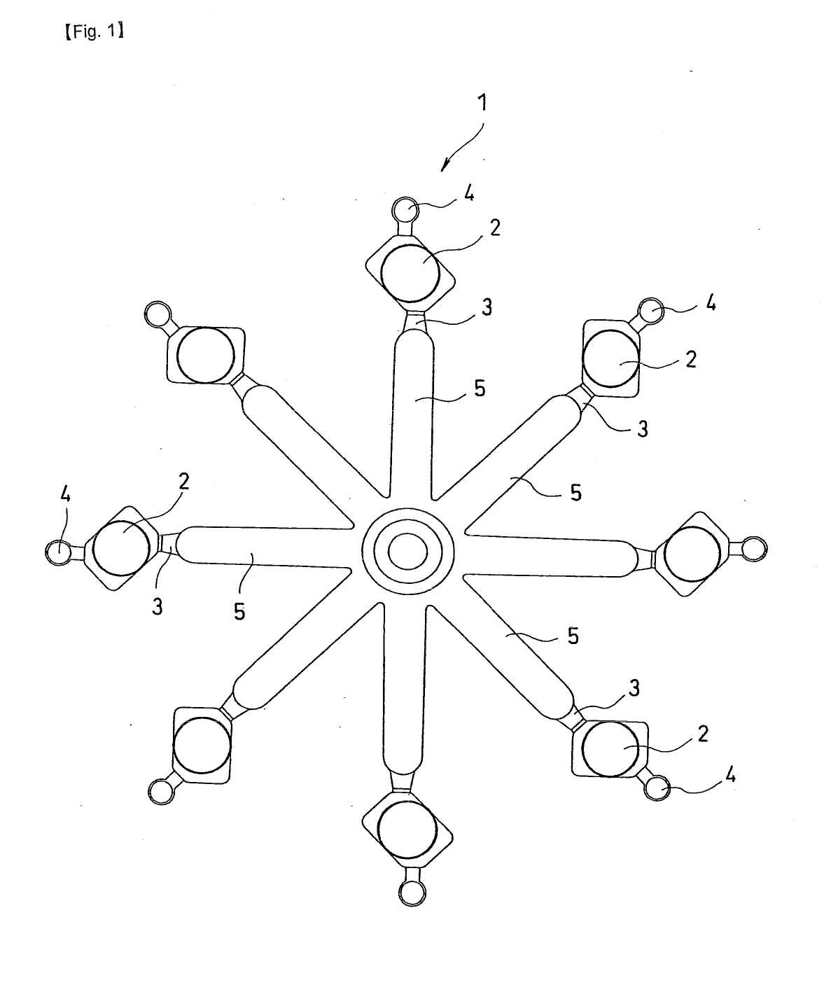

FIGS. 1 to 7 are views illustrating a first embodiment of the present invention.

Firstly, a resin molded article according to the embodiment will be described.

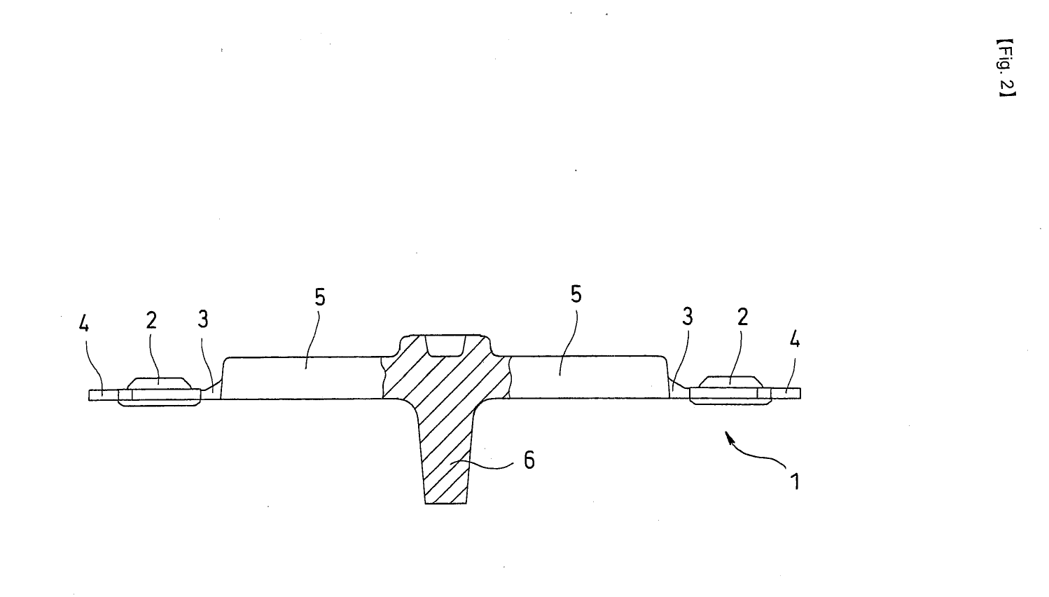

As shown in FIGS. 1 and 2, a resin molded article 1 may be formed through a liquid injection molding method (LIM method) using a mold disclosed in Japanese Patent Application No. 2006-73625 filed by the inventor of the present invention. Namely, in a case where a product part 2 (in the embodiment, a transparent optical device such as a lens, for example, a convex lens, Fresnel lens, or the like) is molded through a liquid injection molding method using a thermosetting resin such as silicone, a mold is provided with an overflow catcher portion, so that bubbles are prevented from remaining in the product part 2. Therefore, the resin molded article 1 which can be obtained by using the invention disclosed in the patent application includes an overflow part 4 which is formed in the overflow catcher portion as well as a gate part 3 in an outer circumference portion of the product part 2. The gate part 3 is connected to a runner part 5, and the runner part 5 is connected to a sprue portion 6 which is formed as a resin inflow path. The resin molded article 1 has eight holding branches capable of obtaining eight products in one-time molding process. In each holding branch, the runner part 5, the gate part 3, the product part 2, and the overflow part 4 are connected to each other in this order in a substantially straight line. As viewed from a plane, the holding branches are radially disposed in an equal interval around the sprue portion 6 which has a substantially truncated cone.

Next, an injection molding apparatus according to the embodiment will be described.

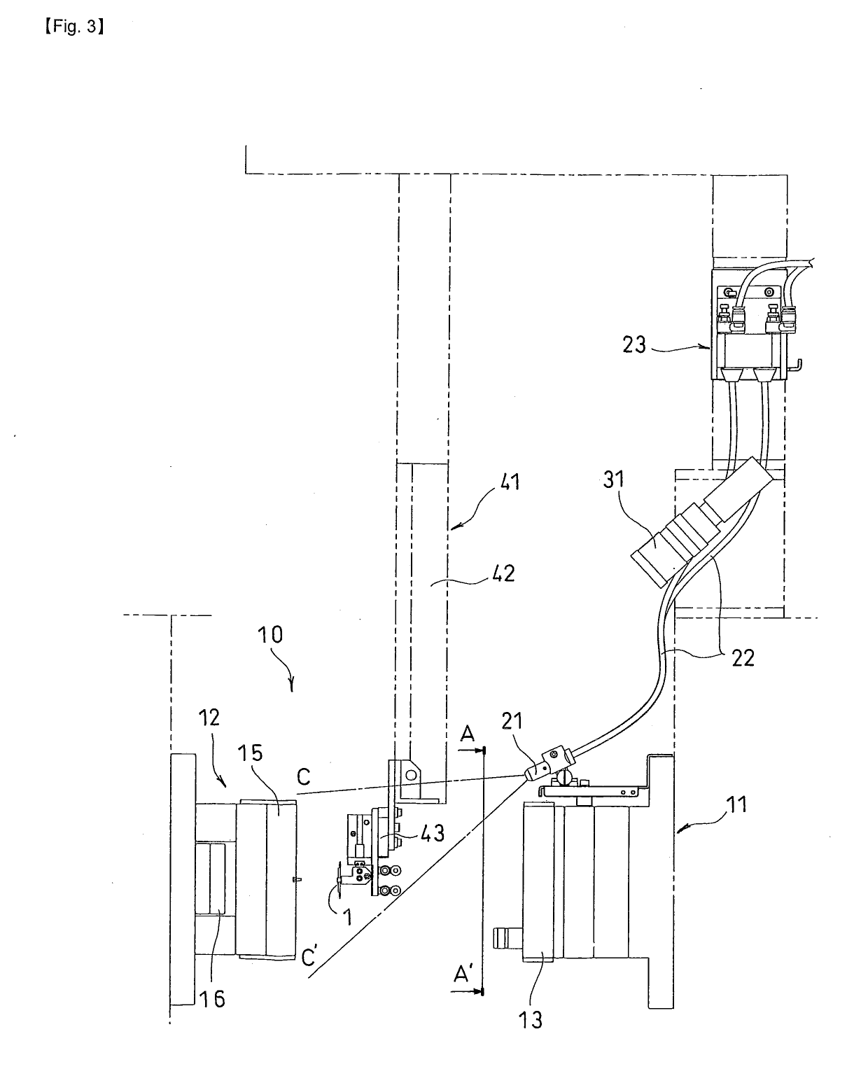

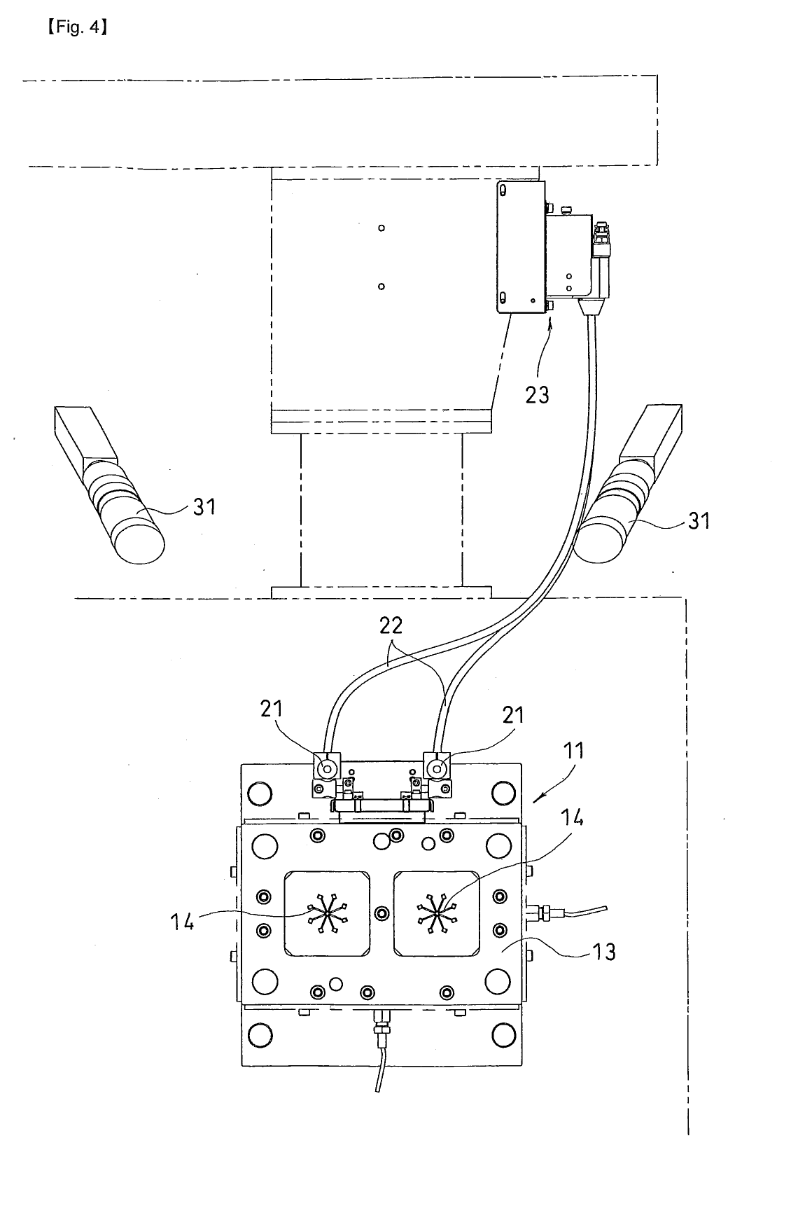

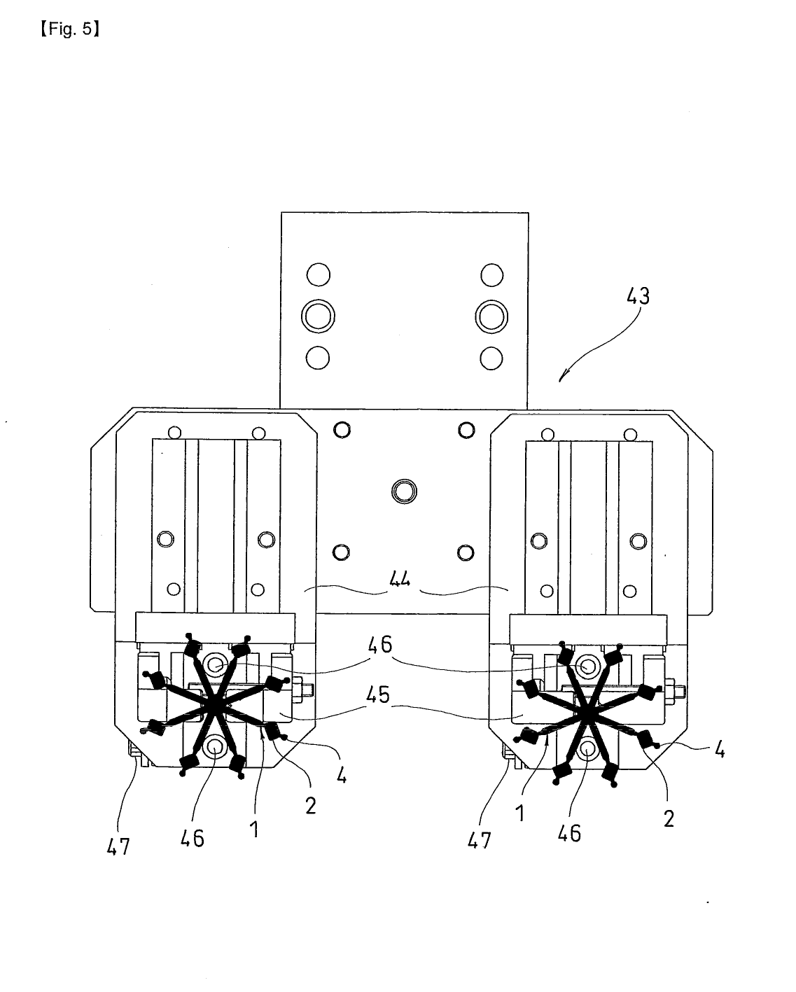

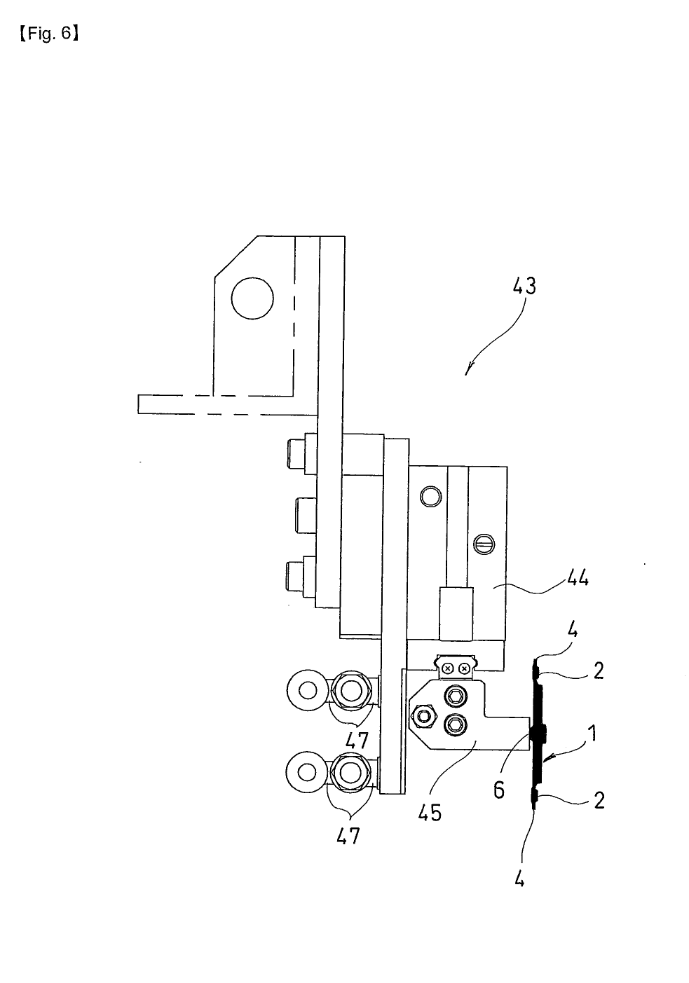

FIGS. 3 to 7 are views illustrating the injection molding apparatus according to the embodiment. FIG. 3 is a side view illustrating the injection molding apparatus. FIG. 4 is a view taken along arrow line A-A of FIG. 3. FIG. 5 is a front view illustrating an extracting chuck assembly of an extracting unit of the injection molding apparatus. FIG. 6 is a side view illustrating the extracting chuck assembly of the extracting unit.

As shown in FIG. 3, a mold 10 of the injection molding apparatus includes a fixed side mold 11 and a movable side mold (mold) 12. As shown in FIG. 4, two (left and right) forming planes 14 and 14 for forming the resin molded article 1 shown in FIG. 1 are provided on a fixed side mold plate (cavity plate) 13 of the fixed side mold 11, and similarly, two left and right forming planes are also provided on a movable side mold plate (core plate) 15 of the movable side mold 12. Therefore, two resin molded articles 1 can be obtained by one-time molding process. In FIG. 1, since one resin molded article 1 has eight product parts 2 along the circumference around the sprue portion 6, each forming plane 14 of the fixed side mold plate 13 for the resin molded article 1 has eight cavity forming planes along the circumference, and similarly, each forming plane of the movable side mold plate 15 for the resin molded article 1 has eight cavity forming planes along the circumference.

As shown in FIG. 3, the movable side mold 12 is provided with an ejector plate 16 to which a protrusion pin (not shown) is fixed. In the demolding process for the resin molded article 1, the ejector plate 16 is moved, so that the resin molded article 1 is pushed out from the movable side mold plate 15 of the movable side mold 12 by protruding the protrusion pin.

On the other hand, above the fixed side mold 11, two (left and right) air spraying nozzles (gas spraying means) 21 and 21 are disposed to be separated to each other by a distance. Each of the air spraying nozzles 21 and 21 is connected to a neutralizing unit 23 through each of pipe lines 22 and 22. The neutralizing unit 23 is connected to an air supply source such as a compressor through a filter. The air supplied from the air supply source is cleaned by the filter, and by the neutralizing unit 23, a neutralizable air (an air containing ions) can be obtained. Furthermore, instead of the air or in addition to the air, other gases such as a carbon acid may be used.

Each of the left and right air spraying nozzles 21 and 21 sprays out the air on a substantially central portion of each of the forming planes of the left and right resin molded articles 1 on the movable side mold plate 15 of the movable side mold 12. Namely, the left air spraying nozzle 21 sprays out the air on the central portion of the forming plane of the left resin molded article 1 on the movable side mold plate 15, in the left portion of the movable side mold plate 15, and the right air spraying nozzle 21 sprays out the air on the central portion of the forming plane of the right resin molded article 1 on the movable side mold plate 15, in the right portion of the movable side mold plate 15. The spraying ranges are overlapped with each other in the central region in the left and right directions. Each of spraying ranges of the left and right air spraying nozzles 21 and 21 in the up and down directions are a range C-C′ of FIG. 3, which substantially cover the movable side mold plate 14 in the up and down directions.

In addition, the injection molding apparatus is provided with an extracting unit 41 which extracts the resin molded article 1 from the movable side mold 12. The extracting unit 41 includes an arm 42 and an extracting head 43 disposed at a lower end of the arm 42. The arm 42 is designed to move in the up and down directions and in the horizontal direction so as to lift down the extracting chuck assembly 43 between the fixed side mold 11 and the movable side mold 12 or to move the extracting chuck assembly to be approached to or separated from the movable side mold 12.

As shown in FIGS. 5 and 6, the extracting head 43 is provided with two extracting chuck assemblies 44 and 44 which are separated from each other by a distance in the left and right portions. Each of the extracting chuck assemblies 44 and 44 is provided with the corresponding one of chucks 45 and 45. Each of the left and right chucks 45 and 45 clamps each of the sprue portions 6 and 6 of the left and right resin molded articles 1 and 1 to extract each of the resin molded articles 1 and 1 from the movable side mold 12.

In addition, each of the left and right extracting chuck assemblies 44 and 44 is provided with a plurality of (in the embodiment, two upper and lower) air spraying holes 46 and 46 (gas spraying means). Similarly to the air spraying nozzles 21 and 21, each of the air spraying holes 46 and 46 is connected through each of pipe lines 47 and 47 via a neutralizing unit and a filter to the air supply source. Therefore, the air supplied to the air spraying holes 46 and 46 is a neutralized, clean air.

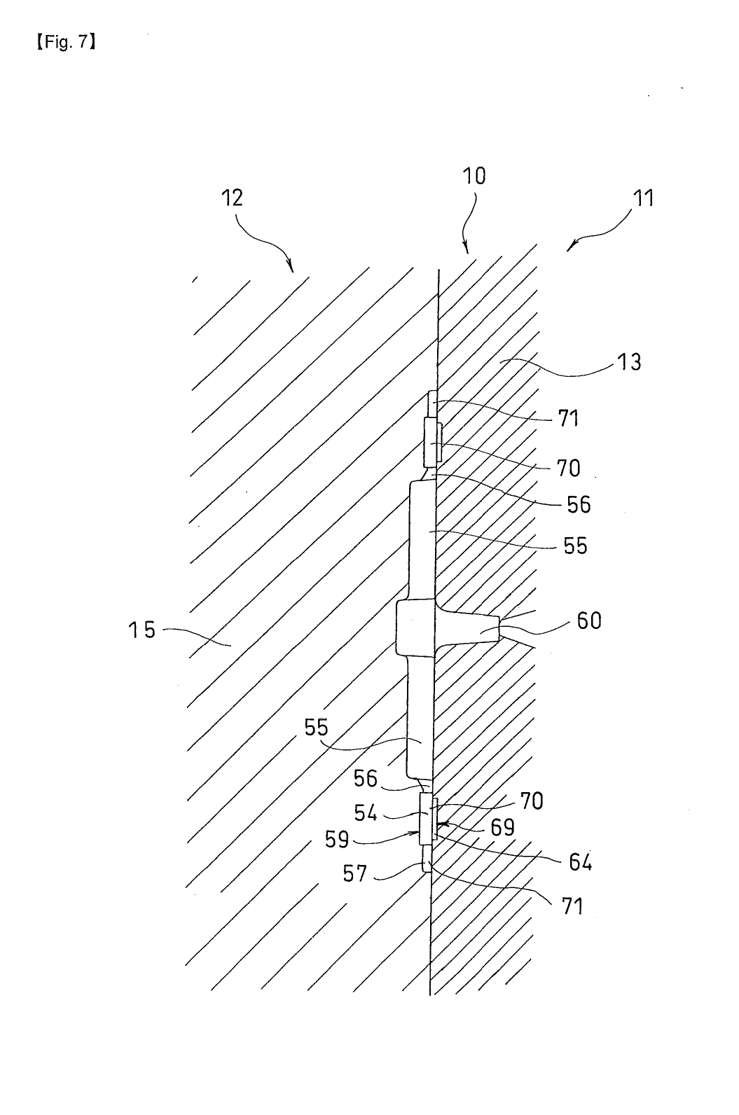

Next, the mold 10 will be described in detail with reference to FIG. 7.

FIG. 7 illustrates a portion of the forming plane for forming the resin molded article 1 (refer to FIGS. 1 and 2) in the movable side mold plate 15 and the fixed side mold plate 13 of the mold 10.

On a surface of the movable side mold plate 15 facing the fixed side mold plate 13, a movable side cavity 54, a runner 5, a gate 56, a movable side overflow catcher 57, and a movable side forming plane 59 having a gas vent (not shown) connected to the movable side overflow catcher 57 are disposed.

In addition, in the fixed side mold plate 13, a sprue 60 is disposed, and on a surface of the fixed side mold plate facing the movable side mold plate 15, a fixed side forming plane 69 having a fixed side cavity 64 is formed.

By abutting the movable side mold plate 15 on the fixed side mold plate 13, the runner 55, the gate 56, and the gas vent of the movable side mold plate 15 close the opening side (of the fixed side mold plate 13). Therefore, the movable side cavity 54 of the movable side mold plate 15 and the fixed side cavity 64 of the fixed side mold plate 13 are combined with each other to form the cavity 70, and the movable side overflow catcher 57 of the movable side mold plate 15 and the fixed side mold plate 13 are combined with each other to form the overflow catcher 71. In this case, cross sections of the gate 56 and the overflow catcher 57 have a substantially circular shape, but not limited thereto. The cross sections may have a polygonal shape.

The cavity 70 is a portion which is to be filled with a resin to form the product part (molded article main body) 2. The gate 56 is used as an inlet of injecting the resin into the cavity 70. The runner 55 is used as a path of resin flown from the sprue 60 into the gate 56. In addition, in case of eight holding branches, the runners 55 are used as paths for flowing the resin into a plurality of the cavities 70. In the mold 10 having eight holding branches, a plurality of the cavities 70 are radially disposed around the sprue 60.

The overflow catcher 71 becomes a space disposed to be connected to a finally-filled position of the cavity 70 where the resin is finally filled or to a vicinity of the finally-filled position. In the state that the cavity 70 is filled with the resin, the overflow catcher is further filled with the resin. Therefore, the resin is overflown from the cavity 70 into the overflow catcher 71, so that the overflow catcher is filled.

The overflow catcher 71 is disposed at the finally-filled position or in the vicinity thereof, for example, a position opposite to a connection to the gate 56 of the cavity 70 or a furthest position in the stream of the resin filled from the gate 56 of the gate 70.

The runner 55 for molding the runner part 5 and the overflow catcher 71 for molding the overflow part 4 are disposed at positions opposite to the movable side cavity 54 where the product part 2 is formed. In addition, on the forming plane of the runner 55 and the overflow catcher 71 of the movable side mold plate 15, protrusion pins (not shown) are disposed to be protrudable. After molding, by striking the protrusion pins on the runner part 5 and the overflow part 4 of the resin molded article 1 simultaneously, the resin molded article can be demolded.

In this case, preferably, the gate part 3 or the overflow part 4 of the resin molded article 1 needs to have a strength to the extent that it cannot be destructed by a pushing pressure of the protrusion pin, and in order to prevent concentration of a stress, the first cross section of a connection portion between the cavity 70 and the overflow catcher 71 is equal to the second cross section of a connection portion between the cavity 70 and the gate 56. Accordingly, it is possible to prevent destruction caused from the concentration of a stress on one of the gate part 3 and the overflow part 4. In this case, if the first cross section is substantially equal to the second cross section, or if the first cross section is within +/−10% of the second cross section, it is possible to prevent concentration of an excessive stress on the one.

In addition, dimensions or a shape of the overflow catcher portion 71 may be suitably designed according to a shape, a volume, or the like of the cavity 70. In this case, it is preferable that the dimensions or shape of the overflow catcher 71 is designed so that the volume of the overflow catcher 71 becomes 10 to 100% of the volume of the cavity 70. In addition, it is preferable that a width (or diameter) of the overflow catcher 71 is equal to or about 10 times of a diameter of the gas vent. In a case where the overflow catcher 71 is constructed so that the volume and dimensions of the overflow catcher 71 is designed to be in the aforementioned range, a gas in the cavity 70 can be more efficiently and surely extracted through the overflow catcher 71 and the gas vent.

In addition, although the gas vent (not shown) is disposed at the position of the overflow catcher 16 where the resin is finally filled, the gas vent may be omitted at the time of the vacuum molding where vacuum suction of the cavity 15 or the like is performed in the injection molding.

In addition, in the embodiment, the runner 5 and the gate 6 are disposed to only the movable side mold plate 15. However, alternatively, the runner and the gate may be disposed to both of the movable side mold plate 15 and the fixed side mold plate 14, and the runner and the gate can be constructed by facing the movable side mold plate and the fixed side mold plate. In addition, alternatively, the overflow catcher 71 may be disposed to only the fixed side mold 13.

As described above, this mold 10 includes the gate 56 which commutes with the cavity 70 to guide the liquid resin into the cavity 70 and the overflow catcher 71 which is a space which commutes with the cavity 70 to receive the liquid resin overflown from the cavity 70.

In the above mold 10, the liquid thermosetting resin is injected into the sprue 60 by the nozzle of the injection molding apparatus, and the liquid resin is flown from the sprue 60 through the runner 55 and the gate 56 to fill the cavity 70. At this time, a gas such as air in the mold 10 is pushed out from the gas vent. In addition, in case of the vacuum molding, the state of vacuum suction is sustained at the time of filling of the liquid resin, so that the air pressure can be sustained to be low. In the vacuum molding, the gas vent may be omitted.

In addition, even though the cavity 70 is completely filled with the liquid resin, an additional liquid resin is supplied, so that the liquid resin is overflown from the cavity 70 into the overflow catcher 71. In addition, a filling amount (injection amount) of the liquid resin is preliminarily set to an amount so that the overflow catcher 71 is almost filled with the resin.

At this time, for example, in the state that the gas vent is thin and the gas is not sufficiently extracted, in a case where the overflow catcher 71 is not provided, bubbles remains in a distal end of the liquid thermosetting resin which is filled into the cavity 70. In the embodiment where the overflow catcher 71 is provided, a resin containing bubbles is flown into the overflow catcher 71, and no bubbles remain in the cavity 70, so that there is no influence to the product part 2 which is molded in the cavity 70.

On the other hand, in some case, although the gas vent has a large diameter and gas is sufficiently extracted, a portion of the liquid resin flown into the overflow catcher 71 is flown into the gas vent, and thus, blurs may occur. Even in the case, as described later, the blurs together with an overflow part 4 are removed at the time of cutting the overflow part 4 which is formed with the resin flown into the overflow catcher 71. Therefore, a process of removing only the blurs is not needed.

Therefore, the diameter of the gas vent needs not to be designed as an optimal value. Accordingly, the gas vent can be easily designed at the time of manufacturing the mold 10.

Next, the liquid injection molding method using the aforementioned mold 10 will be described.

The thermosetting resin used in the embodiment is, for example, a silicone resin. However, in addition to the silicone resin, other liquid thermosetting resins may be used.

Preferably, a viscosity of the thermosetting resin is 1500 to 15000 d pas at 25° C. In particular, the thermosetting resin is preferably a silicone resin. In addition to the silicone resin, as an example of the thermosetting resin having the above properties, there is a phenol resin, a polyester resin, an epoxy resin, an area resin, a melamine resin, and the like.

In addition, an example of the product part 2 of the resin molded article 1 is an optical device such as a resin lens. However, the mold and the liquid injection molding method according to the present invention can be adapted to device other than the optical device.

In the liquid injection molding method is based on the liquid injection molding method (LIM method).

In the liquid injection molding method, the mold 10 is closed by abutting the movable side mold plate 15 on the fixed side mold plate 13, and an internal temperature of the mold is adjusted to be a high temperature, for example, about 150° C. Next, the liquid thermosetting resin is injected through the sprue 60 of the fixed side mold plate 13 into the runner 55. At this time, since the temperature of the mold is adjusted to be a high temperature, the liquid resin starts to be hardened at the time of the injecting, but the liquid resin in the flowing region is not hardened. As described above, the liquid resin injected into the mold 10 is approached from the sprue 60 through the runner 55 to the gate 56, so that the liquid resin is filled from the gate 56 into the cavity 70. The liquid resin overflown from the cavity 70 is approached to the overflow catcher 71. In addition, as described above, the injecting amount of resin also includes the amount that is filled into the overflow catcher 71.

The liquid thermosetting resin flown in to the cavity 70 is filled into the cavity 70 by pushing out the air of the cavity 70 into the overflow catcher 71. The air pushed out into the overflow catcher 71 is extracted through the gas vent. Next, an additional pressure is exerted so as to mold the thermosetting resin flown into the cavity 70 with a shape of product. Particularly, in a case where the product part 2 is an optical device or the like, a high pressure is exerted to mold the product with a high accuracy.

In addition, when the liquid resin is flown into the cavity 70, the liquid resin of the cavity 70 is also flown into the overflow catcher 71. Next, until the liquid resin is filled into the overflow catcher 71, the liquid resin is flown into the cavity 70. In addition, at the time that the overflow catcher 71 is filled with the liquid resin, the molding process is ended. At this time, the liquid resin heated in the mold 10 is hardened without movement of the liquid resin.

In the molding process, in a case where bubbles occur in the liquid resin, the resin containing bubbles is flown into the overflow catcher 71, so that it is possible to prevent bubbles from remaining in the cavity 70. Although the air pushed out into the overflow catcher 71 is extracted through the gas vent, all the air is not extracted. However, it has no problem that bubbles may remain in the overflow catcher 71. Since the overflow part 4 which is hardened in the overflow catcher 71 is to be cut off from the product part 2, it has no problem that the bubbles may remain in the overflow catcher 71.

Next, as shown in FIG. 3, the mold opening is performed, and at the almost same time, air spraying from the left and right air spraying nozzles 21 and 21 starts.

Next, the ejector plate 16 of the movable side mold 12 is moved so as to simultaneously strike the runner part 5 and the overflow part 4 with the protrusion pins which are disposed on the forming plane of the runner 55 and the overflow catcher 71 of the movable side mold plate 15, so that the whole of the resin molded article 1 is pushed out from the movable side mold plate 15 of the movable side mold 12.

In addition, air is sprayed to the left and right resin molded articles 1 and 1 of the movable side mold plate 15 by the left and right air spraying nozzles 21 and 21 to cool (quench) the resin molded articles 1 and 1, so that the resin molded articles land 1 are rapidly shrunk. In this state, resin molded articles 1 and 1 are protruded from the movable side mold plate 15 by the protrusion pin. Therefore, resin molded articles 1 and 1 are smoothly demolded from the movable side mold plate 15. At this time, since the first cross section of a connection portion between the cavity 70 and the overflow catcher 71 is within +/−10% of the second cross section of a connection portion between the cavity 70 and the gate 56, the resin molded articles can be demolded without destruction caused from the concentration of a stress on one of the gate part 3 and the overflow part 4.

At the time of demolding, it is preferable that the air is sprayed so that the air can be further infiltrated into an interstice between the resin molded articles 1 and 1 and the movable side mold plate 15, which is formed due to a shrinkage of the resin molded articles 1 and 1 caused from the air sprayed by the air spraying nozzles 21 and 21. By doing so, the resin molded articles 1 and 1 are also cooled by the air sprayed from the interstice, so that the resin molded articles 1 and 1 can be efficiently cooled. In the embodiment, the air spraying nozzles 21 and 21 are located in the upper portion to be slanted with respect to the resin molded articles 1 and 1, so that the air can be sprayed in the slanted direction to the resin molded articles 1 and 1. Therefore, the air can be easily infiltrated into the interstice.

In addition, the blurs of the movable side mold plate 15 may be removed by the air sprayed by the air spraying nozzles 21 and 21.

Next, when the protrusion by the protrusion pins is ended, an image of the movable side mold plate 15 of the movable side mold 12 picked up by cameras 31 and 31 are analyzed by an image processing apparatus so as to check whether or not the product part 2, the overflow part 4, or the like of the resin molded article 1 (remaining portions of the molded article) remains in the fixed side mold plate 13 of the fixed side mold 11.

If the portions of the molded article remain, a start command is not issued to the extracting unit 41, but a molding-apparatus cycle over error is informed.

If the portions of the molded article do not remain, the extracting head 43 of the extracting unit 41 is lifted down to be located between the fixed side mold 11 and the movable side mold 12, so that each of the extracting chuck assemblies 44 and 44 is allowed to face each resin molded article 1.

In addition, in this case, the air spraying from the air spraying nozzles 21 and 21 is designed to stop when the protrusion by the protrusion pins is ended. However, according to the demolding states of each of the resin molded articles 1 and 1, that is, according to a result of checking whether or not each of the resin molded articles 1 and 1 is smoothly demolded, the air extracting time (stop timing) or the air extracting amount may be suitably set.

Next, the extracting head 43 is moved forward (that is, approached to the movable side mold 12), and each of the sprue portions 6 and 6 of each of the resin molded articles 1 and 1 is clamped with the left and right chucks 45 and 45 of each of the extracting chuck assemblies 44 and 44 (refer to FIGS. 5 and 6).

Next, just after the clamping, air spraying from the air spraying holes 46 and 46 of each of the extracting chuck assemblies 44 and 44 starts. By spraying the air from the air spraying holes 46 and 46 to the resin molded articles 1 and 1, each of the electrically-charged resin molded articles 1 and 1 can be neutralized (electricity-removed) by ions in the sprayed air, and at the same time, cooled.

Next, the extracting head 43 is moved backward (that is, separated from the movable side mold 52), and after that, lifted upward so as to be located at an outside of a space between the fixed side mold 11 and the movable side mold 12.

Next, the image picked up by the cameras 31 and 31 are analyzed by the image processing apparatus so as to check whether or not the product part 2, the overflow part 4, or the like of the resin molded article 1 remains in the movable side mold plate 15 (to check whether or not portions of the molded article remains).

If the portions of the molded article remain, a start command for mold closing is not issued to the extracting unit 41, but a molding-apparatus cycle over error is informed.

If the portions of the molded article do not remain, the mold closing is performed.

In addition, the resin molded article 1 extracted from the mold 10 by the extracting unit 41 is carried to a processing apparatus of the next process by the extracting unit 41.

In this case, the air spraying from the air spraying holes 46 and 46 is designed to stop until the resin molded article is carried into the next processing apparatus. However, according to the neutralization state of each of the resin molded articles 1 and 1, that is, according to a result of checking whether or not each of the resin molded articles 1 and 1 is neutralized to be easily detached from the chucks 45 and 45 of the extracting unit 41, the air extracting time (stop timing) or the air extracting amount may be suitably set.

Next, by the extracting unit, the resin molded article 1 is extracted from the mold 10 and carried to a processing apparatus which performs the next process, that is, the cutting process. In the cutting process, a connection portion between the product part 2 and the gate part 3 and a connection portion between the product part 2 and the overflow part 4 are cut by the processing apparatus so as to separate the product part 2 from the gate part 3 and the overflow part 4. As a result, the product part 2 is obtained. In addition, it is preferable that the cutting is simultaneously performed.

Here, after the molding, the gate part 3 or the overflow part 4 is cut off from the product part 2. After that, in a case where a post process such as a cutting process or a polishing process is not performed, a first cut plane formed by cutting the overflow part 4 and a second cut plane formed by cutting the gate part 3 remain in the product part 2. The first cut plane and the second cut plane substantially correspond to the first cross section and the second cross section of the mold. Namely, the area of the first cut plane of the product part 2 is within +/−10% of the area of the second cut plane.

In addition, according to an inspection of an optical lens (product part 2) manufactured according to the embodiment, it was observed that no bubbles occurred in the lens and desired optical characteristics were obtained.

In the embodiment, the overflow catcher 71 is disposed to be opposite to the gate 56 of the cavity 70, but the present invention is not limited thereto. The overflow catcher may be disposed at an arbitrary position according to a shape of the resin molded article. It is preferable that, in order to more surely push out a gas in the cavity 70 into the overflow catcher 71, the overflow catcher 71 may be disposed to the finally-filled position of the liquid thermosetting resin in the cavity 70 or to a vicinity thereof. Therefore, in a case where the finally-filled position of the thermosetting resin is in the vicinity of the gate 56 of the cavity 70, the overflow catcher 71 may be disposed to the vicinity of the gate 56 of the cavity 70.

In addition, the description of the embodiment is made with respect to a case of one overflow catcher 71, but the present invention is not limited thereto. A plurality of the overflow catchers may be disposed.

### Second Embodiment

Now, a second embodiment of the present invention will be described.

Firstly, a resin molded article according to the embodiment is constructed, similarly to that of the first embodiment.

Next, an injection molding apparatus according to the embodiment will be described.

The injection molding apparatus according to the embodiment has the same construction as that of the first embodiment except for a mold. Therefore, the description of the entire construction of the injection molding apparatus is omitted, but the description is concentrated on the mold.

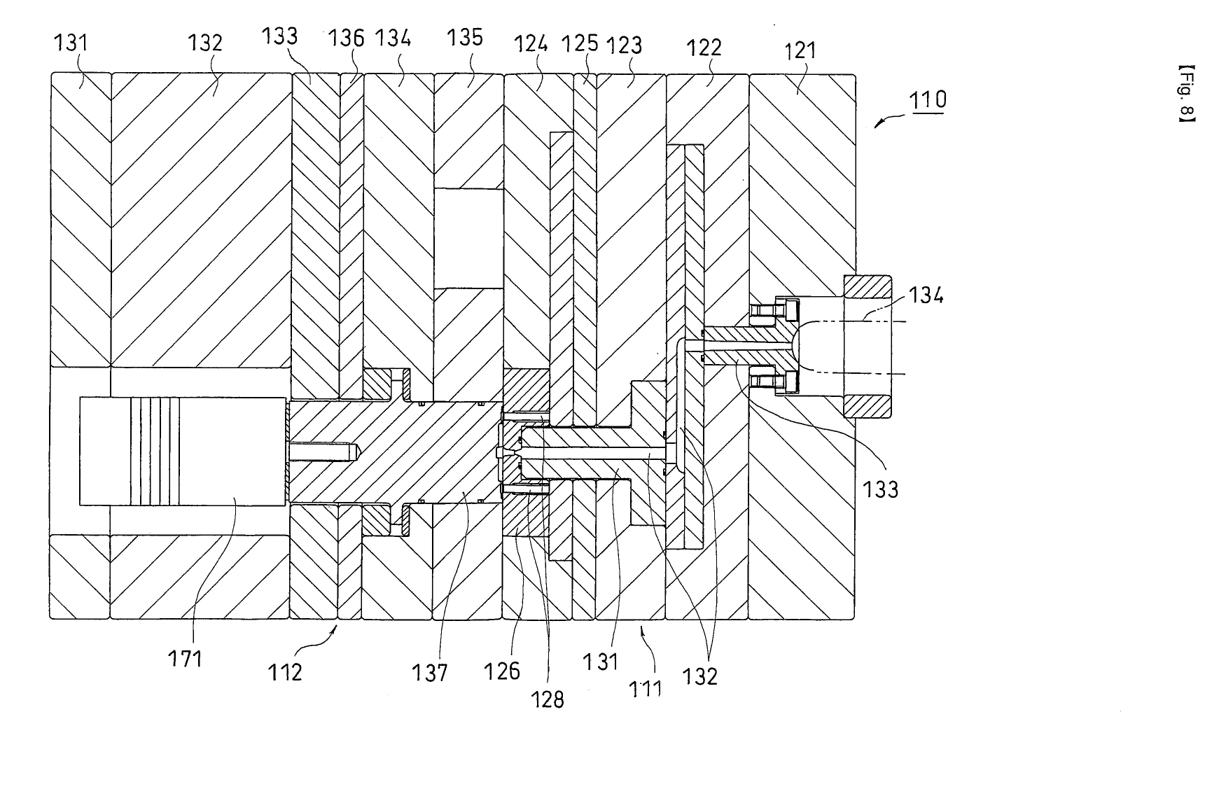

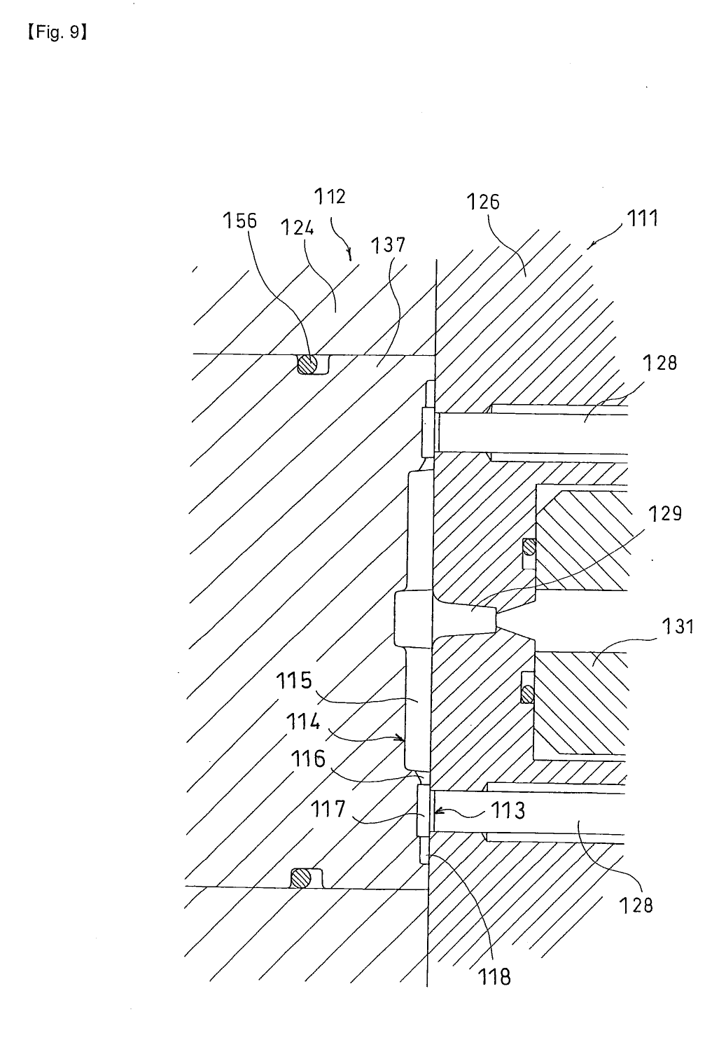

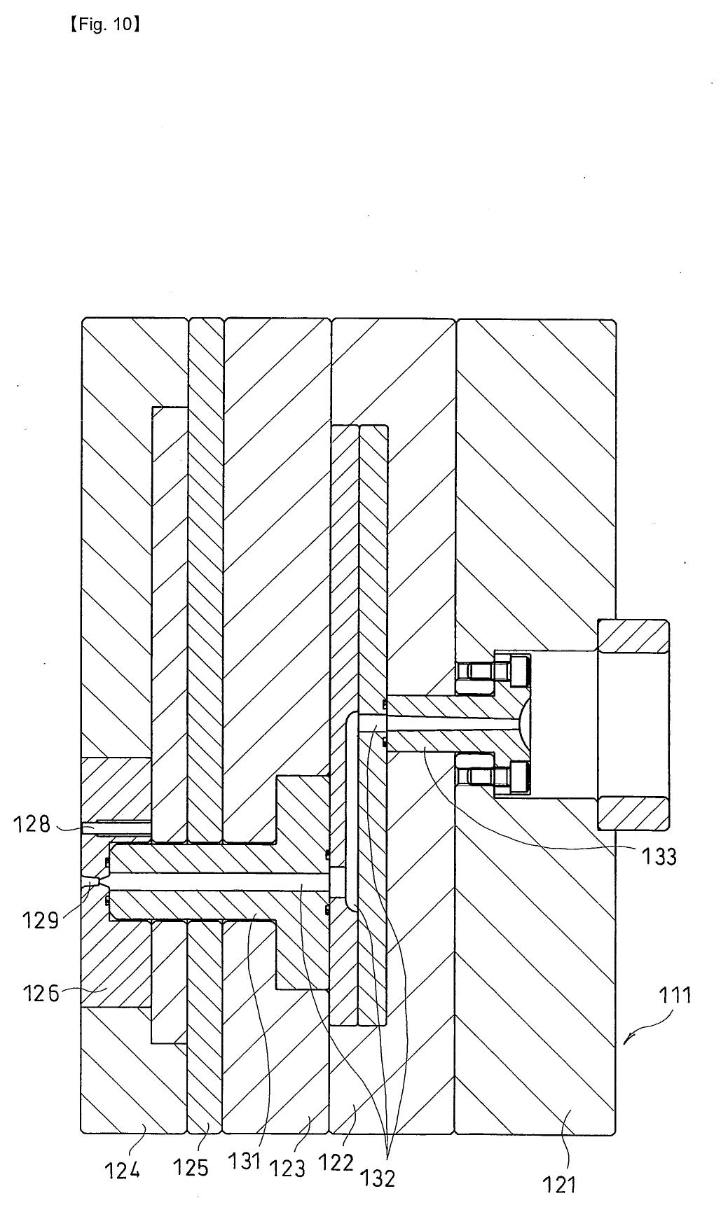

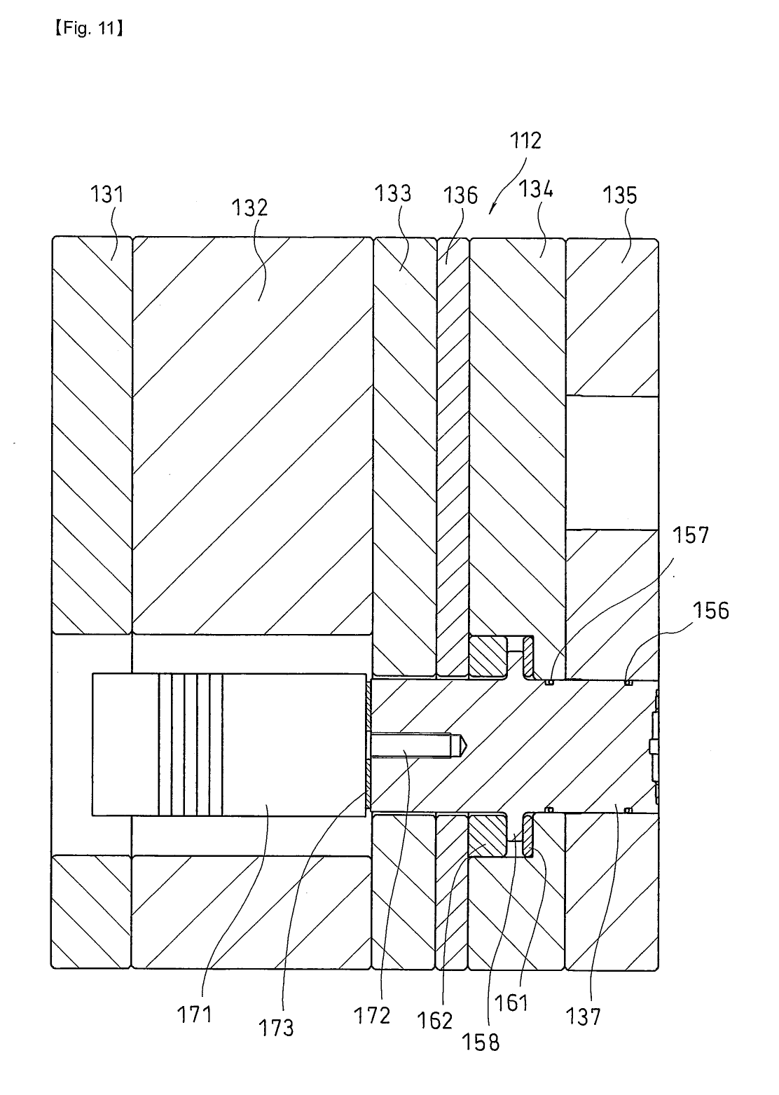

FIGS. 8 to 12 are views illustrating the mold of the injection molding apparatus according to the embodiment. FIG. 8 is a schematic cross sectional view illustrating the mold. FIG. 9 is an enlarged view illustrating principal components of FIG. 8. FIG. 10 is a schematic cross sectional view illustrating a fixed side mold of the mold. FIG. 11 is a schematic cross sectional view illustrating a movable side mold of the mold. FIG. 12 is a detailed enlarged view illustrating principal components of FIG. 11.

As shown in FIG. 8, the mold 110 of the injection molding apparatus includes a fixed side mold 111 and a movable side mold (mold) 112. The mold 110 is provided with two forming planes for forming the resin molded article 1 shown in FIG. 1, so that two resin molded articles 1 can be molded by one-time molding process.

As shown in FIGS. 8 to 10, the fixed side mold 111 is provided with a fixed side attaching plate 121 and an a fixed side mold plate (cavity plate) 124 which is attached to the fixed side attaching plate 121 through a plurality of the receiving plates 122 and 123. A heat insulating plate 125 is interposed between the fixed side mold plate 124 and the receiving plate 123. A cavity insert 126 is disposed to the fixed side mold plate 124, and a forming plane for forming a whole of the resin molded article 1 shown in FIG. 1 is disposed on a front surface of the cavity insert 126. The forming plane (front surface) of the cavity insert 126 is formed to be flat except for a portion corresponding to the sprue portion 106. The cavity insert 126 is provided with eight pins 128. Cavity forming planes corresponding to the eight product parts 102 disposed along the circumference around the sprue portion 106 in the resin molded article 1 shown in FIG. 9 are formed on front end surfaces of the pins 128. The pin 128 is inserted from the heat insulating plate 125 into a through-hole of the cavity insert 126, and a large-diameter engagement portion (not shown) is engaged with a step difference portion (not shown) of the through-hole of the cavity insert 126, so that the pin 128 is prevented from protruding over the front end side from the through-hole. The front end surface of the pin 128 is slightly recessed from the front surface of the cavity insert 126.

In addition, a sprue 129 having a substantially truncated cone, which functions as a resin inflow path, is disposed in the central portion of the cavity insert 126. The sprue 129 is constructed to commute with the resin inflow path 132 provided to the sprue unit 131 and the like, so that the resin injected from a nozzle 134 of the resin injector into a bush 133 fixed to a fixed side attaching plate 186 is flown through the inflow path 132 to the sprue 129. The heat insulating plate 125 has functions of suppressing heat transfer from a resin molded article forming portion to the fixed side receiving plate 123 and ensuring a fluidity of resin in the inflow path 132. In addition, for efficiently performing the functions, the sprue unit 131 and the like are water-cooled by using a water cooling pipe or the like.

In addition, as shown in FIGS. 8, 9, 11, and 12, the movable side mold 112 is provided with a movable side attaching plate 131 and a movable side mold plate (core plate) 135 which is attached to the movable side attaching plate 131 through a plurality of receiving plates 132, 133, and 134. A heat insulating plate 136 is interposed between the movable side mold plate 135 and the receiving plate 134. A cavity insert 137 having a substantially cylindrical shape is disposed to the movable side mold plate 135, and a forming plane for forming a whole of the resin molded article 1 shown in FIG. 9 is disposed on a front surface of the cavity insert 137. The forming plane is formed to be a concave portion by digging a portion of the front flat surface of the cavity insert 137.

As shown in detail in FIG. 12, the cavity insert 137 is provided with eight pins 138. Cavity forming planes corresponding to the eight product parts 102 disposed along the circumference around the sprue portion 106 in the resin molded article 1 shown in FIG. 9 are formed on front end surfaces of the pins 138. The pin 138 is provided with a small-diameter portion 138a at the front end surface and a large-diameter portion 138b at the rear end surface to be inserted into a through-hole 139 which is formed in the cavity insert 137 to have a small-diameter part 139a at the front surface side and a large-diameter part 139b at the rear surface side. In addition, in the pin 138, a spacer 140 is interposed at the front side of the large-diameter portion 138b of the pin 138 with respect to the front end portion of the large-diameter part 139b of the through-hole 139, and at the same time, two hexagonal hole-attached stopper screws 41 are engaged with female screws of the rear end portion of the large-diameter part 139b of the through-hole 139. As a result, the position of the pin 138 in the forward and backward directions (that is, the axial direction) and, accordingly, the position of the cavity forming plane of the front end of the pin 138 is determined, and at the same time, the pin 138 is prevented from protruding from the through-hole 139 to the rear end side.

Next, the cavity insert 137 is disposed in the following manner. As shown in FIG. 12, a through-hole 151 of the movable side mold plate 135 is provided with a flange-attached bush 152. The cavity insert 137 is inserted into a cylindrical through-hole 153 of the receiving plate 134, a cylindrical through-hole 154 of the heat insulating plate 136, and a cylindrical through-hole 155 of the receiving plate 133 in an inner side of the bush 152. In addition, thin interstices are disposed between the inner circumference surface of the bush 152 and the inner circumference surface of the through-hole 153 of the receiving plate 134 and the outer circumference surface of the cavity insert 137. The cavity insert 137 is fitted into the bush 152 and the through-hole 153 of the receiving plate 134 through O-rings (elastic members) 156 and 157, so that the radial position of the cavity insert 137 can be fixed. Each of the O-rings 156 and 157 is disposed into a corresponding O-ring groove formed on the outer circumference surface of the cavity insert 137.

In addition, a flange portion 158 of the cavity insert 137 having a disk shape which protrudes outwards is formed in the central portion of the cavity insert 137 in the forward and backward directions (mold abutting surface side is defined as the front side). On the other hand, in the rear end side of the through-hole 153 of the receiving plate 134, an opened ring-shaped notched portion 159 is formed on the rear surface of the receiving plate 134 and the through-hole 153, so that the flange portion 158 of the cavity insert 137 is inserted into the notched portion 159. In addition, ring-shaped spacers 161 and 162 are disposed at the front and rear sides of the flange portion 158. The spacers 161 and 162 are interposed to the inner surface of the front side of the notched portion 159 and the front surface of the heat insulating plate 136, so that the flange portion 58 is interposed between the spacers 161 and 162. In this case, a sum of the width of the flange portion 158 and the widths of the spacers 161 and 162 is designed to be slightly smaller than a width (depth) of the notched portion 159. The spacers 161 and 162 are made of a low-frictional material having a low friction coefficient such as bakelite. The flange portion 158 can be slid in the radial direction between the spacers 161 and 162. At the time of injecting the resin, the cavity insert 137 is pushed toward the rear surface. However, at this time, since the rear surface of the flange portion 158 of the cavity insert 137 is abutted on the front surface of the spacer 162, the position of the cavity insert 137 in the forward and backward directions (that is, the axial direction) and, accordingly, the position of the forming plane for forming the resin molded article 1 in the front surface of the cavity insert 137 can be determined according to the width of the spacer 162 which is abutted on the front surface of the heat insulating plate 139. In addition, an outer diameter of the flange portion 158 is designed to be smaller than a diameter of an inner surface of the notched portion 159 in the radial direction, so that an interstice 164 is formed in the outer circumference of the flange portion 158.

The mold 110 is a mold used for the vacuum molding. As shown in FIG. 12, a suction path 165 is provided to the bush 152 and the receiving plate 135 of the movable side mold 12. The one end of the suction path 165 is opened to a mold abutting surface (parting line), and the other end is connected to a vacuum apparatus (not shown) for the vacuum suction. In order to sustain sealing of the resin molded article forming portion, O-rings (sealing members) 156 and 167 are interposed between the cavity insert 137 and the bush 152 and between the bush 152 and the movable side mold plate 135. In addition, an O-ring (sealing member) 168 is disposed on an abutting surface between the bush 152 and the receiving plate 134 to surround the suction path 165. As described above, the O-ring 156 also has a function of forming an interstice between the bush 152 and the cavity insert 137. Each of the O-rings 167 and 168 are disposed into a corresponding O-ring groove formed on the outer circumference surface of the bush 152 and the abutting surface of the receiving plate 134. In addition, in order to sustain sealing of the resin molded article forming portion, an O-ring (sealing member) 169 is disposed to a mold abutting surface between the movable side mold plate 135 and the cavity insert 26 of the fixed side mold 111 to surround the bush 152. The O-ring 169 is disposed into an O-ring groove formed on the mold abutting surface of the movable side mold plate 135.

In addition, an ultrasonic vibrator 171 is disposed on the rear surface of the cavity insert 137. More specifically, a bolt portion 172 is disposed in the central portion of the front surface of the ultrasonic vibrator 171. The bolt portion 172 is engaged with a female screw 137b formed in the center of the rear surface of the cavity insert 137 through a washer 173 made of a heat insulating material such as ceramics. Due to the use of the heat insulating washer 173, the heat of the resin molded article forming portion can be prevented from being transferred to the ultrasonic vibrator 171. For the same reason, the heat insulating plate 136 is interposed between the receiving plates 133 and 134. In addition, a pipe line 174 for temperature adjusting is disposed around the ultrasonic vibrator 171, so that an increase in temperature of the ultrasonic vibrator 171 can be prevented. The ultrasonic vibrator 171 is provided with a plurality of piezoelectric devices 175, so that a distal end portion thereof is vibrated at a high frequency by applying an AC voltage. Accordingly, the cavity insert 137 is vibrated at a high frequency. The ultrasonic vibrator 171 is designed to have an oscillating frequency of 27 kHz and a vibration width of about 10 μm. In this case, the cavity insert 137 can function as a horn. Therefore, in the forward and backward directions, the cavity insert 137 has a maximum of amplitude at the front surface portion and the rear surface portion and an amplitude of 0 (zero) at the flange portion 158, and in the radial direction, the cavity insert 137 has a maximum of amplitude at the flange portion 158.

In the embodiment, the fixed side forming plane 113 formed in the fixed side mold 111 and the movable side forming plane 114 formed in the movable side mold 112 are constructed as fixed planes which are not moved.

Now, an injection molding method using the aforementioned injection molding apparatus will be described.

As described above, since the injection molding apparatus according to the embodiment performs the same liquid injection molding method as that of the first embodiment except for the structure of the mold, the description of the injection molding apparatus according to the first embodiment except for the mold is replaced with the drawings. In addition, since the thermosetting resin, the product part, or the like are the same as those of the first embodiment, the description thereof is omitted or simplified.

Firstly, vacuum suction is performed on a whole of the cavity through a suction path 165 of a vacuum apparatus, so that a reduced pressure state is obtained. In this state, a thermosetting resin such as a silicone resin is injected into the mold 110 to mold the resin molded article 1. More specifically, a liquid thermosetting resin is injected from a nozzle of the injection molding apparatus to a sprue 129. The sprue 129, the runner 115, the gate 116, and the cavity 117 are sequentially filled with the resin. In addition, the injecting amount of resin also includes the amount that is filled into the overflow catcher 118.

Next, mold opening is performed.

Next, the extracting head 43 is moved forward (that is, approached to the movable side mold 112, and left and right chucks 45 and 45 of each of the extracting chuck assemblies 44 and 44 are disposed at positions in the vicinity of each of the runner parts 5 and 5 of each of the resin molded articles 1 and 1, where separation of each of the resin molded articles 1 and 1 from the movable side mold 112 during the demolding using the ultrasonic vibration can be prevented.

During the mold opening operation and/or after the mold opening, the cavity insert 137 is vibrated with the ultrasonic vibrator. Therefore, an air layer is generated between the cavity insert 137 and the resin molded article 1 hermetically contacting the cavity insert 137, so that the resin molded article 1 can be demolded from the cavity insert 137.

In addition, in the embodiment, at the almost same time of the mold opening, air spraying from the left and right air spraying nozzles 21 and 21 starts. Air is sprayed to the left and right resin molded articles 1 and 1 of the movable side mold plate 135 by the left and right air spraying nozzles 33 and 33 to cool (quench) the resin molded articles 1 and 1, so that the resin molded articles 1 and 1 are rapidly shrunk. In this case, it is preferable that the air is sprayed so that the air can be further infiltrated into an interstice between the resin molded articles 1 and 1 and the movable side mold plate 135, which is formed due to a shrinkage of the resin molded articles 1 and 1 caused from the air sprayed by the air spraying nozzles 21 and 21.

In addition, in the embodiment, when the left and right chucks 45 and 45 of each of the extracting chuck assemblies 44 and 44 are located at predetermined positions, the air spraying from the air spraying holes 46 and 46 of each of the extracting chuck assemblies 44 and 44 start. By spraying the air from the air spraying nozzles 33 and 33 and the air spraying holes 46 and 46 to the resin molded articles 1 and 1, each of the electrically-charged resin molded articles 1 and 1 can be neutralized (electricity-removed) by ions in the sprayed air, and at the same time, cooled. Therefore, each of the resin molded articles 1 and 1 is more smoothly demolded from the movable side mold plate 135. In addition, the blurs of the movable side mold plate 135 may be removed by the sprayed air.

In addition, the cavity insert 137 is supported in the bush 152 and the receiving plate 134 through O-rings 156 and 157 which are elastic members, and interstices are formed between the cavity insert 137 and the bush 152 and between the cavity insert 137 and the receiving plate 134. Therefore, the cavity insert 137 has a function of ensuring an accurate position at the time of forming the resin molded article 1 by resin injection and curing and a function of ultrasonically vibrating at the time of the demolding. In addition, the ultrasonic vibration cannot be easily transferred to the mold plate.

In addition, although the flange portion 158 of the cavity insert 137 has a maximum of amplitude in the radial direction, since an interstice 164 is formed at the outer circumference of the flange portion 158, the flange portion 158 is slid in the radial direction between the spacers 161 and 162, so that the ultrasonic vibration can be performed.

In the molding process (including the demolding process), since the movable side forming plane 114 and the fixed side forming plane 113 are constructed as fixed planes which are not moved, there is no leakage of the silicone resin from any one of the movable side forming plane 114 and the fixed side forming plane 113.

The hermetical contacting between the resin molded articles 1 and 1 and the cavity insert 137 is released due to the ultrasonic vibration, so that the resin molded articles 1 and 1 are demolded. Next, each of the sprue portions 106 and 106 of each of the resin molded articles 1 and 1 is clamped by the left and right chucks 45 and 45 of each of the extracting chuck assemblies 44 and 44. Next, the extracting head is moved backwards (that is, separated from the movable side mold 112), and after that, lifted upward so as to be located at an outside of a space between the fixed side mold 111 and the movable side mold 112.

Next, the image picked up by the cameras 31 and 31 are analyzed by the image processing apparatus so as to check whether or not the product part 102, the overflow part 104, or the like of the resin molded article 1 remains in the cavity insert 137 (to check whether or not portions of the molded article remains).

If the portions of the molded article remain, a start command is not issued to the extracting unit 41, but a molding-apparatus cycle over error is informed. If the portions of the molded article do not remain, the mold closing is performed.

The resin molded article 1 extracted from the mold 110 by the extracting unit is carried to a processing apparatus of the next cutting process by the extracting unit.

In the cutting process, a connection portion between the product part 2 and the gate part 3, a connection portion between the product part 2 and the overflow part 4 are cut by the processing apparatus so as to separate the product part 2 from the gate part 3 and the overflow part 4. As a result, the product part 2 is obtained. In addition, it is preferable that the cutting is simultaneously performed.

In the injection molding method and the injection molding apparatus for the resin molded article, during the mold opening operation or after mold opening, the cavity insert 137 is vibrated with the ultrasonic vibrator 171, but the protrusion by the protrusion pin is not performed. Therefore, even in a case where the resin molded article 1 is molded by a liquid injection molding method using a thermosetting resin such as a silicone resin which has a low viscosity and a high fluidity so that blurs easily occur, the resin molded article 1 can be smoothly and simply demolded from the cavity insert 137 of the movable side mold 112 without destruction of the resin molded article 1. In addition, even in a case where the resin molded article 1 includes the gate part 3 or the overflow part 4 as well as product part 2, the resin molded article can be smoothly demolded from the cavity insert 137, so that the destruction of the overflow part 4 or the gate part 3 can be prevented. In addition, even in a case where the product part 2 of the resin molded article 1 is a transparent optical device such as an optical lens with a small size and has a plurality of holding branches, for example, eight holding branches, the resin molded article can be smoothly demolded from the cavity insert 137, so that some portions of the resin molded article 1 can be prevented from remaining in the cavity insert 137.

In addition, since the protrusion by the protrusion pin is not performed, a structure of the movable side mold 112 can be simplified, and there no need to dispose an abutting portion to the resin molded article 1, to which the protrusion pin is abutted. If the resin molded article 1 is completely formed without an abutting portion to which the protrusion pin is to abutted, and if the resin molded article 1 has such as a small product part 2 as a transparent optical device, for example, an optical lens, it is unnecessary to enlarge the gate part 3 or the like so as to ensure the abutting portion. In addition, since there is no need to delay a production speed in consideration of the destruction of the gate part 3 or the like similarly to the case of the protrusion by the protrusion pin, a working time for demolding can be greatly reduced, so that it is possible to improve work efficiency.

In addition, since the cavity insert 137 having the forming plane for forming the whole of the resin molded article 1 is ultrasonically vibrated, there is no problem in that, in case of vibrating some portion of the product part, some portions of the resin molded article 1, for example, a portion between the product part 2 and the gate part 3, the runner part 5, or other portions may be easily destructed. In addition, the cavity insert 137 (including the pin 138) having the forming plane for forming the whole of the resin molded article 1 is not moved with respect to the movable side mold plate 135 at the time of the molding. Therefore, unlike a movable piece disclosed in Patent Document 1, there is no need for performing a process of removing a resin which is infiltrated into an interstice between the movable piece and a movable mold (movable mold plate), during the molding, in order to ensure movement of the movable piece.

In addition, since the cavity insert 137 is supported in the bush 152 and the receiving plate 134 disposed to the movable side mold plate 112 through the O-rings 156 and 157 which are elastic members, interstices are formed between the cavity insert 137 and the bush 152 and between the cavity insert 137 and the receiving plate 134. Therefore, the cavity insert 137 has a function of ensuring an accurate position at the time of forming the resin molded article 1 by resin injection and curing and a function of ultrasonically vibrating at the time of the demolding. In addition, the ultrasonic vibration cannot be easily transferred to the mold plate.

In addition, the O-ring 156 as an elastic member also has a function as a sealing member for sustaining sealing of a resin molded article forming portion at the time of vacuum molding, so that it is possible to simplify a structure of the movable side mold 112.

In addition, since the cavity insert 137 is provided with the flange portion 158 so that position fixing is performed by interposing the flange portion 158, it is possible to simplify a structure of the movable side mold 112, and at the same time, the position fixing can be accurately performed by setting a suitable thickness of each of the spacers 161 and 162.

In addition, since the interstice 164 is formed at the outer circumference of the flange portion 158 of the cavity insert 137, the flange portion 158 is slid in the radial direction between the spacers 161 and 162, so that the ultrasonic vibration can be performed.

In addition, since the ultrasonic vibrator 171 is disposed to the cavity insert 137 through the washer 173 made of a heat insulating material such as ceramics, heat transferred from the resin molded article forming portion to the ultrasonic vibrator 171 can be suppressed, so that it is possible to prevent occurrence of a problem caused from an increase in temperature of the ultrasonic vibrator 171. In addition, the heat insulating plate 136 interposed between the receiving plates 133 and 134 also contributes to preventing occurrence of the problem in the ultrasonic vibrator 171.

In addition, in the aforementioned embodiment, the movable side mold 112 is provided with the cavity insert 137 through the bush 152. However, alternatively, the bush 152 may be omitted.

In addition, in the aforementioned embodiment, the cavity insert 137 is designed to be supported in the receiving plate 134 through an elastic member, that is, the O-ring 157. However, alternatively, the O-ring 157 may be disposed between the cavity insert 137 and the bush 152 or between the cavity insert 137 and the other receiving plate 133 or the heat insulating plate 136. In addition, the O-ring 157 may be omitted.

In addition, in the aforementioned embodiment, the spacers 161 and 162 which interposes the flange portion 158 of the cavity insert 137 is made of a low-frictional material having a low friction coefficient as bakelite, and the flange portion 158 can be slid in the radial direction between the spacers 161 and 162, so that the flange portion 158 can be ultrasonically vibrated. However, alternatively, an elastic member such as an O-ring is interposed between the flange portion 158 and the spacers 161 and 162 so as to form interstices between the flange portion 158 and the spacers 161 and 162. Accordingly, the flange portion 158 can be ultrasonically vibrated between the spacers 161 and 162.

In addition, in the aforementioned embodiment, the cavity insert 137 is provided with the pin 138 where the cavity forming plane is formed. However, alternatively, the pin 138 may not be provided, but the cavity forming plane may be formed in the cavity insert 137.

In addition, in the aforementioned embodiment, the resin molded article 1 which is designed to hermetically contact the cavity insert 137 of the movable side mold plate 135 is demolded from the cavity insert. However, alternatively, the resin molded article may be designed to hermetically contact the cavity insert of the fixed side mold plate, and the cavity insert may be demolded by ultrasonic vibration.

In addition, in the aforementioned embodiment, after the resin molded article 1 is demolded from the cavity insert 137 by ultrasonic vibration, the resin molded article 1 is clamped by the extracting unit to be extracted from the cavity insert 137. However, alternatively, the resin molded article 1 may be detached (extracted) from the cavity insert 137 by only the ultrasonic vibration.

In addition, in the aforementioned embodiment, the ultrasonic vibration means together with the air spraying means is used. However, alternatively, only the ultrasonic vibration means may be used to demold the resin molded article 1 from the cavity insert 137.

### Third Embodiment

Now, a third embodiment of the present invention will be described.

An injection molding apparatus according to the embodiment has the same construction as that of the second embodiment except for a mold. Therefore, the description of the entire construction of the injection molding apparatus is omitted, but the description is concentrated on the mold.

The mold according to the third embodiment is almost the same as that of the first embodiment, but a relationship between a first cross section of a connection portion between a cavity for forming a connection portion and an overflow catcher and a second cross section of a connection portion between the cavity and a gate is different from that of the mold according to the aforementioned first embodiment. Therefore, description for the components of the mold according to the third embodiment, which are the same as those of the mold according to the first embodiment, will be omitted or simplified.

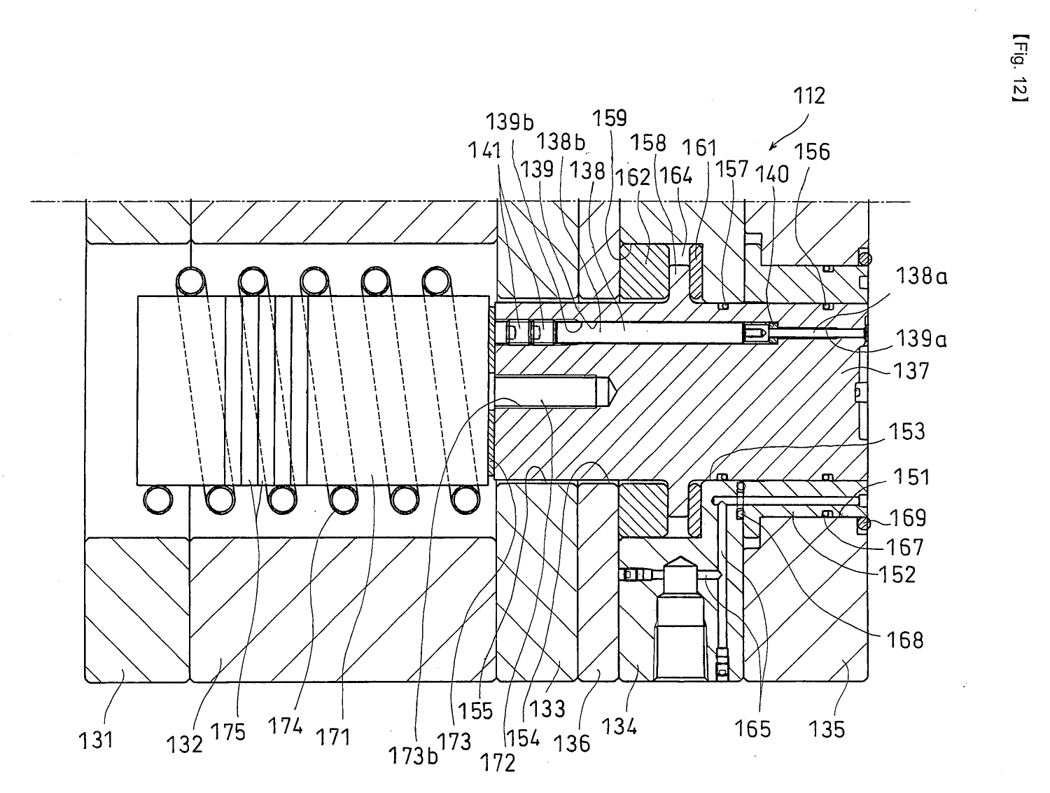

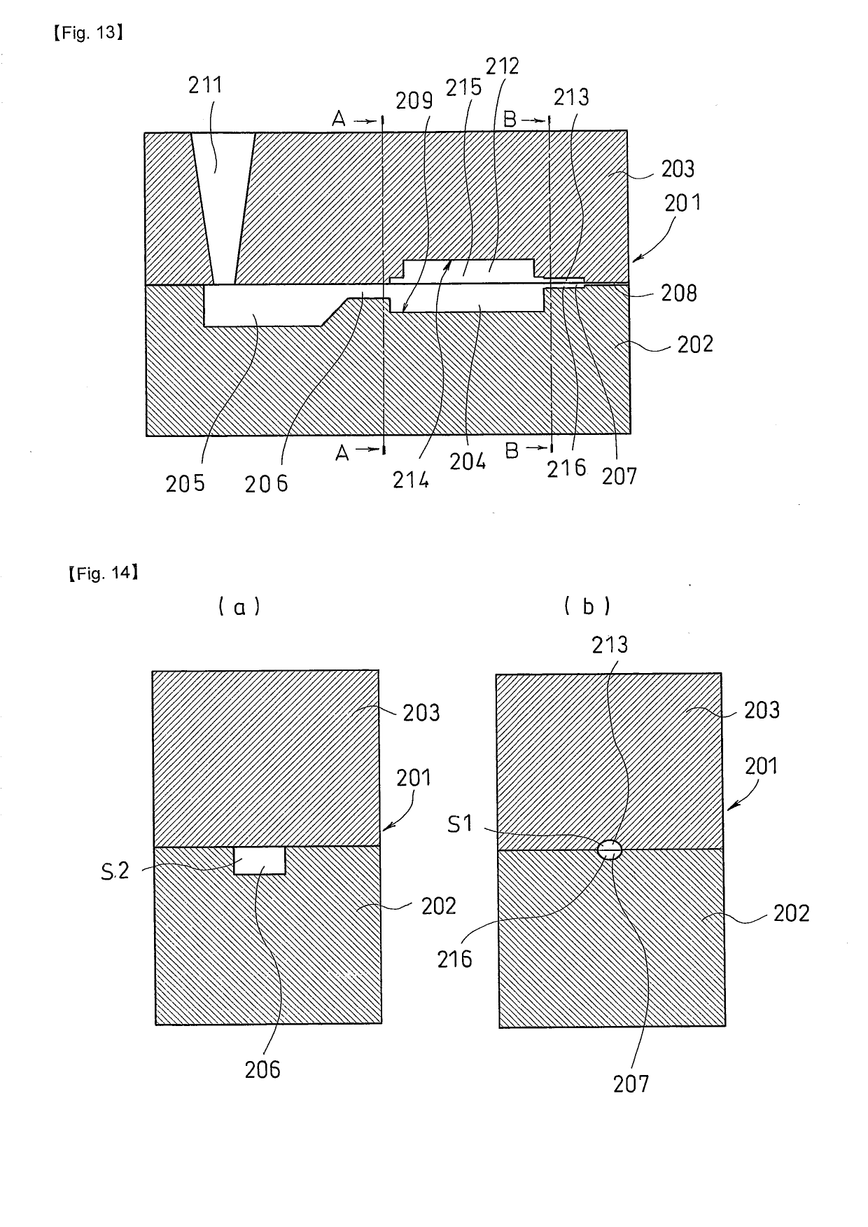

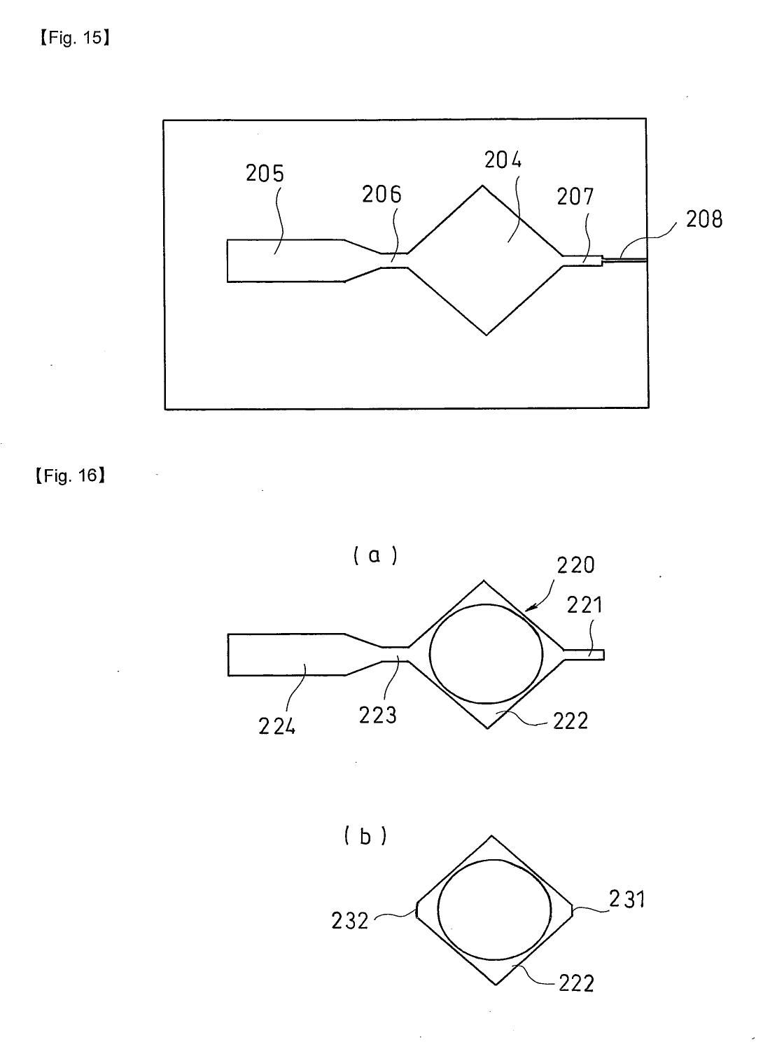

FIGS. 13 to 15 are views illustrating the third embodiment of the present invention. FIG. 13 is a cross sectional view diagrammatically illustrating the mold. FIG. 14(a) is a cross sectional view taken along line A-A of FIG. 13, and FIG. 14 (b) is a cross sectional view taken along line B-B of FIG. 13. FIG. 15 is a plan view diagrammatically illustrating a movable side mold of the mold. In addition, these figures are views illustrating a portion of a forming plane for forming a resin molded article.

As shown in FIG. 13, the mold 201 includes a movable side mold (movable mold) 202 and a fixed side mold (fixed mold) 203.

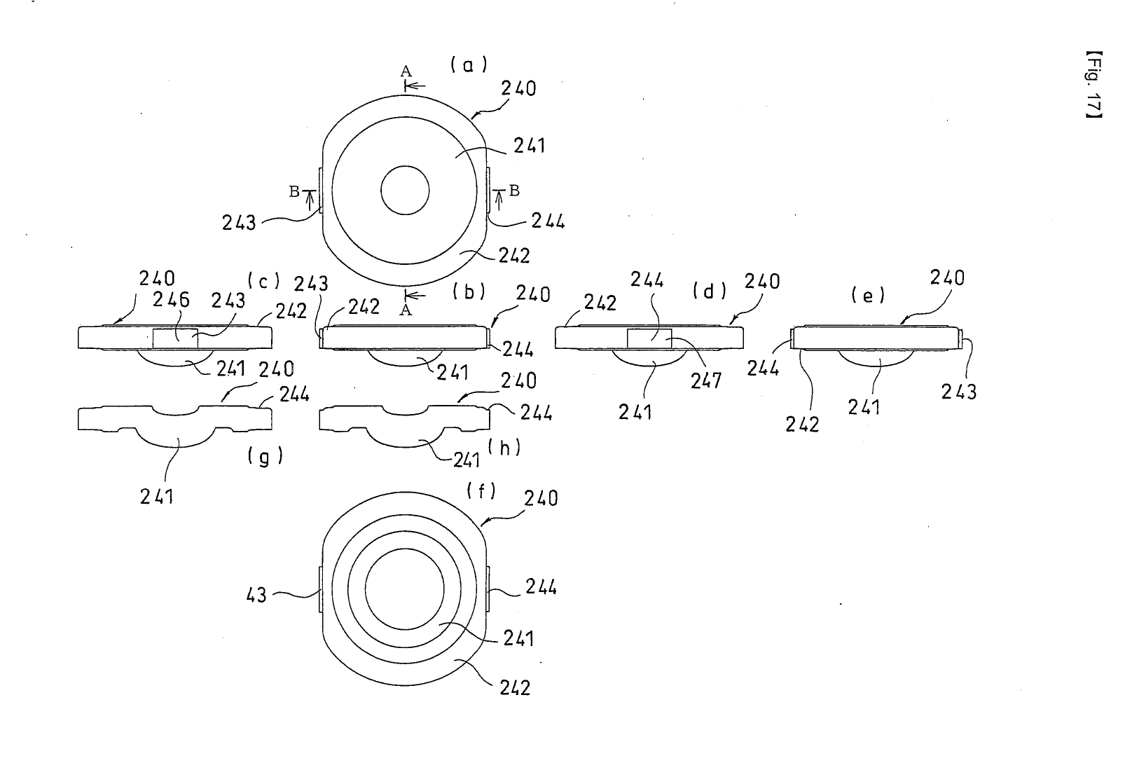

In the embodiment, the resin molded article 220 (refer to FIG. 16) is formed by a liquid injection molding method where a liquid thermosetting resin is injected into a heated mold 201 and thermally cured.

Similarly to the aforementioned third embodiment, the movable side mold 202 according to the embodiment is a cavity insert having a forming plane for forming the resin molded article 220, and after the liquid resin is injected, the cavity insert is vibrated with an ultrasonic vibrator (not shown) which is connected to the cavity insert, so that the resin molded article 220 can be demolded from the mold 201.

In addition, a movable side forming plane 209 including a movable side cavity 204, a runner 205, a gate 206, a movable side overflow catcher 207, and a gas vent 208 is formed on a surface of the movable side mold 202 facing a fixed side mold 203. As described in the second embodiment, the movable side forming plane 209 is constructed as a fixed plane which is not moved.

In addition, in the fixed side mold 203, a sprue 211 is disposed, and on the surface of the movable side mold 202, a fixed side forming plane 214 having a fixed side cavity 212 and a fixed side overflow catcher 213 is formed. As described in the second embodiment, the fixed side forming plane 120 is also constructed as a fixed plane which is not moved. In addition, in case of performing vacuum molding in an injection molding apparatus, there is no need to dispose a gas vent.

In addition, by abutting the movable side mold 202 on the fixed side mold 203, the runner 205, the gate 206, and the gas vent 208 of the movable side mold 202 close the opening sides (of the fixed side mold 203). Therefore, the movable side cavity 204 of the movable side mold 202 and the fixed side cavity 212 of the fixed side mold 203 are combined with each other to form a cavity 215, and the movable side overflow catcher 207 of the movable side mold 202 and the fixed side overflow catcher 213 of the fixed side mold 203 are combined with each other to form an overflow catcher 216.

The overflow catcher 216 becomes a space disposed to be connected to a finally-filled position of the cavity 215 where the resin is finally filled or to a vicinity of the finally-filled position. In the state that the cavity 215 is filled with the resin, the overflow catcher is further filled with the resin. Therefore, the resin is overflown from the cavity 215 into the overflow catcher 216.

In addition, a gas vent 208 is disposed at the position of the overflow catcher 16 where the resin is finally filled. In addition, at the time of the injection molding, vacuum molding may be performed for vacuum suction of the cavity 215 or the like. In this case, the gas vent 208 may be omitted.

In addition, in the embodiment, the runner 205 and the gate 206 are disposed to only the movable side mold 202. However, alternatively, the runner and the gate may be disposed to both of the movable side mold 202 and the fixed side mold 203, so that the runner and the gate can be constructed by facing the movable side mold plate and the fixed side mold plate. In addition, alternatively, the overflow catcher 216 may be disposed to only the movable side mold 202.

As shown in FIG. 16, the demolded resin molded article 220 includes a product part (molded article main body) 222 which is formed in the cavity 215 of the mold 201, a gate part 223 which is formed in the gate 6 which commutes with the cavity 215 to guide a liquid resin, a runner part 224 which is formed in the runner 205 which guides out the liquid resin into the gate part 223, and an overflow part 221 which is formed in the overflow catcher 216 which commutes with the cavity 215 to form a space of receiving the liquid resin overflown from the cavity 215.

In this manner, the mold 201 includes the gate 206 which commutes with the cavity 215 to guide the liquid resin into the cavity 215 and the overflow catcher 216 which commutes with the cavity 215 to form a space of receiving the liquid resin overflown from the cavity 215.

In addition, in the embodiment, a first cross section S1 in a connection portion between the cavity 215 and the overflow catcher 216 is designed to be equal to or less than a second cross section S2 in a connection portion between the cavity 215 and the gate 206.

In addition, in the above mold 201, the liquid thermosetting resin is injected into the sprue 211 by the nozzle of the injection molding apparatus, and the resin is flown from the sprue 211 through the runner 205 and the gate 206 to fill the cavity 215. At this time, a gas such as air in the mold 201 is pushed out from the gas vent 208. The description for the gas vent is the same as that of the first embodiment, and thus, detail description thereof is omitted. In addition, in case of the vacuum molding, the state of vacuum suction is sustained at the time of filling of the resin, so that the air pressure can be sustained to be low. Therefore, in this case, the gas vent may be omitted.

In addition, even though the cavity 215 is completely filled with the liquid thermosetting resin, an additional liquid resin is supplied, so that the liquid resin is overflown from the cavity 215 into the overflow catcher 216. In addition, a filling amount (injection amount) of the thermosetting resin is preliminarily set to an amount so that the overflow catcher 216 is almost filled with resin.

In the embodiment, as described above, the first cross section S1 in a connection portion between the cavity 215 and the overflow catcher 216 is designed to be equal to or less than the second cross section S2 in a connection portion between the cavity 215 and the gate 206.

In the design of the mold 201, the second cross section S2 in the gate 206 is designed so that resin filling for the cavity 215 can be smoothly performed. If the first cross section S1 in the overflow catcher 216 is equal to the second cross section S2, that is, if the first cross section S1 is 1.0 time of the second cross section S2, a resin including bubbles can be smoothly flown into the overflow catcher 216, basically.

In addition, the overflow catcher 216 needs not to flow out an additional resin, but it preferably guides the resin overflown from the cavity 215. Therefore, the first cross section S1 may be designed to less than the second cross section S2.

Namely, in a case where the second cross section S2 for smoothly filling the cavity 215 with the resin is taken as a reference, even through the first cross section S1 is 0.2 times of the second cross section S2, it is observed that a thermosetting resin including bubbles can be flown out from the cavity 215 into the overflow catcher 216.

In addition, if the first cross section S1 is designed to be less than 0.2 times of the second cross section S2, the resin may not be smoothly flown from the cavity 215 into the overflow catcher 216 due to influence of the bubbles occurring in the resin, so that a sufficient effect of removing the bubbles in the product part 222 cannot be expected due to the overflow catcher 216.

In addition, if the first cross section S1 is designed to be 0.2 times of the second cross section S2, the resin including bubbles may not be smoothly flown from the cavity 215 into the overflow catcher 216 under all the conditions. Although the resin including bubbles may not be flown into the overflow catcher 216 under some conditions, it is preferable that the first cross section S1 is designed to be 0.5 times of the second cross section S2 in terms of yield of the molded article.

In addition, as shown in FIG. 16, in a case where the mold 201 is provided with the overflow catcher 216, the gate part 223 formed with the resin cured in the gate 206 and the overflow part 221 formed with the resin cured in the overflow catcher 216 are integrally connected to the product part (molded article main body) 222 of the resin molded article 220, which is formed with the resin filled and cured in the cavity 215.

After the molding, the gate part 223 or the overflow part 221 is cut off from the product part 222. In a case where a post process such as a cutting process and a polishing process is not performed, as shown in FIG. 16(b), a first cut plane 231 formed by cutting off the overflow part 221 and a second cut plane 232 formed by cutting off the gate part 223 remain in the product part 222.

In this case, in a case where an outer appearance of the product part (molded article main body) 222 and a degree of freedom for design of a shape of the product part 222 are taken into consideration, it is preferable that the first cut plane 231 formed by cutting off the overflow part 221 which does not exist in a convention one is designed to be small. In addition, at least, it is preferable that the first cut plane is designed to be equal to or less than the second cut plane 232 formed by cutting off the gate part 223 which exists in the conventional one.

Therefore, as described above, in a case where the ultrasonic vibration is used at the time of demolding the resin molded article from the mold 201, the protrusion pin is not needed, or the pushing pressure of the protrusion pin to the molded article can be reduced. In this case, even if the first cross section S1 is less than the second cross section S2, there is no problem. Accordingly, as described above, the first cross section S1 may be about 0.2 times of the second cross section S2.

Therefore, in the mold 201, it is preferable that the first cross section S1 is 0.2 times to 1.0 time of the second cross section S2. In addition, it is preferable that the first cross section S1 is 0.5 times to 1.0 time of the second cross section S2. In addition, in a case where the ultrasonic vibration is used for the demolding, particularly, the first cross section S1 may be less than 1.0 time of the second cross section S2, or less than 0.9 times of the second cross section S2.

Now, operations performed in the injection molding using the mold described above will be described.

Firstly, the resin molded article 220 is molded in the mold 201 by using a thermosetting resin such as a silicone resin through a liquid injection molding method. More specifically, the liquid thermosetting resin is injected into the sprue 211 by the nozzles of the injection molding apparatus, and the resin is flown from the sprue 211 through the runner 205 and the gate 206 to fill the cavity 215. At this time, a gas such as air in the mold 201 is pushed out from the gas vent. In addition, as described above, an injecting amount of resin also includes the amount that is filled into the overflow catcher 216.

Here, after the molding, the gate part 223 or the overflow part 221 is cut off from the product part 222. After that, in a case where a post process such as a cutting process or a polishing process is not performed, the first cut plane 231 formed by cutting off the overflow part 221 and the second cut plane 232 formed by cutting off the gate part 223 remain in the product part 222. The first cut plane 231 and the second cut plane 232 substantially correspond to the first cross section S1 and the second cross section S2 of the mold.

In the resulting product part (in the embodiment, an optical device) 222 which is molded by using the mold 201, the area of the first cut plane 231 formed by cutting off the overflow part 207 of the product part is equal to or less than the area of the second cut plane 232 formed by cutting off the gate part 223 of the product part 222.

In addition, in a case where an outer appearance of the product part (molded article main body) 222 and a degree of freedom for design of a shape of the product part 222 are taken into consideration, it is preferable that the first cut plane 231 formed by cutting off the overflow part 221 which does not exist in a convention one is designed to be small. In addition, at least, it is preferable that the first cut plane is designed to be equal to or less than the second cut plane 232 formed by cutting off the gate part 223 which exists in the conventional one.

As described above, in the mold 201, it is preferable that the first cross section S1 is designed to be 0.2 times to 1.0 time of the second cross section S2. In addition, it is preferable that the first cross section S1 is designed to be 0.5 times to 1.0 time of the second cross section S2. In the product part 222, it is preferable that the area of the first cut plane 231 is designed to be 0.2 times to 1.0 time of the area of the second cut plane 232. In addition, it is preferable that the area of the first cut plane 231 is designed to be 0.5 times to 1.0 time of the area of the second cut plane 232. In particular, in a case where the product part 222 is an optical device, in order to increase the degree of freedom for design, the first cut plane 231 is preferably designed to be as small as possible. However, if the bubbles remain, an optical device having desired optical characteristics cannot be obtained. Therefore, it is preferable that the area of the first cut plane 231 is in the aforementioned ranges.

For example, in the product part (optical device) 222 shown in FIG. 16(b), a circular portion in the central region is an optical device main body having optical characteristics as an effective optical device, and a rectangular portion in the peripheral region is a flange for fixing the optical device to other elements for example. Here, for example, corner portions of the rectangular flange are cut away at the first cut plane 231 and the second cut plane 232, and thus, the area of the flange is decreased by the cut-away area. Therefore, when the optical device is attached by using the flange, attachment strength may be lowered due to the flange. In addition, since the area of the flange is decreased or the corner portions of the flange are cut away, when the optical device is attached to other elements, installation stability may be deteriorated.

However, in the present invention, since the first cut plane 231 can be designed to be smaller than the second cut plane 232, the notched portion of the flange can be reduced by the first cut plane 231, so that it is possible to obtain a more stable shape.

FIG. 17 illustrates a modified example of a product part (transparent optical device).

An optical device (product part) 240 shown in FIG. 17 is manufactured by using a method and a mold having a construction which are the same as those of the aforementioned third embodiment, except for shapes of a product part such as an optical device, a cavity, and the like. The optical device includes a lens main body 241 having a circular shape in the central region, a flange 242 formed to surround the lens main body, a gate cut portion 243 formed by cutting off a gate part, and an overflow cut portion 244 formed by cutting off an overflow part.

In addition, the overflow cut portion 244 is provided with a first cut plane 247, and the gate cut portion 243 is provided with a second cut plane 246.

In the example, the first cut plane 247 and the second cut plane 246 are designed to have the same area. In addition, the optical device 240 is designed to have a left-right symmetrical shape having a good design-ability and a good left-right balance.

In addition, the optical device 240 basically a circular shape as viewed in plane, and a portion of the gate cut portion 243 and a portion of the overflow cut portion 244 has notched shapes.

In addition, in the aforementioned product part 222, the portions formed by cutting off the gate part and the overflow part may also be designed to protrude outward. However, in a case where the product part is attached to other members, if the portions are formed to protrude from a basic shape, for example, a circle in case of the optical device 240, the protrusion may interrupt the installation of other members.

Therefore, it is preferable that portions where the first cut plane 247 and the second cut plane 246 are formed are designed to be in a notched state that the portions are slightly recessed from the basic shape.

Here, if the first cut plane 247 is shaped to be smaller than the second cut plane 246, the left-right symmetrical shape is destructed. However, since the first cut plane 247 becomes small, the notched portion in the overflow cut portion 244 becomes small, so that the shape of the optical device 240 is further approximated to a circle. Accordingly, by increasing the area of the flange 242, it is possible to improve an installation stability of the optical device 240 to other elements. In addition, in a case where an optical device 240 with a shape having front and rear portions is formed to have a left-right symmetry, the front and rear portions may be confused at the time of installation of the optical device to other elements. However, when the optical device is formed to have a left-right asymmetry, the confusion of the front and rear portions can be prevented.

In the embodiments, the optical device is described by using a silicone resin as an example of the thermosetting resin, but the mold and the liquid injection molding method according to the present invention is not limited thereto. Any resin molded article manufactured by using a thermosetting resin having a low viscosity can be used together with the mold according to the present invention so as to manufacture a good quality of molded article main body (product part) including no bubbles.

In addition, in the embodiments, examples of manufacturing a transparent product part (optical device) are described, but the present invention is not limited thereto. An opaque molded article is also adapted to the mold and the liquid injection molding method according to the present invention. In this case, a good quality of molded article main body (product part) including no bubbles can be obtained, and thus, it is possible to improve characteristics of the molded article main body (product part) such as strength and durability.

1. A method of manufacturing a molded article which is formed with a thermosetting resin by using a mold comprising:
a cavity for molding a product part;
a gate which commutes with the cavity to guide a liquid thermosetting resin into the cavity, thereby forming a gate part;
a runner which commutes with the gate part to guide the liquid resin into the gate part, thereby forming a runner part; and
an overflow catcher which commutes with the cavity to receive the liquid resin overflown from the cavity, thereby forming an overflow part,
wherein the method comprises:
an injecting process of injecting the liquid resin from the runner through the gate to the cavity, until the overflow catcher is filled from the cavity;
a hardening process of heating the liquid resin in the mold, thereby hardening the liquid resin;
a demolding process of demolding a resin molded article having the runner part, the gate part, the product part, and the overflow part from the mold; and
a cutting process of detaching the gate part and the overflow part from the product part of the demolded resin molded article.

2. The method according to claim 1, wherein the overflow catcher of the mold is disposed to be connected to a finally-filled position of the cavity where the liquid resin is finally filled or to a vicinity of the finally-filled position.

3. The method according to claim 1 or 2, wherein the thermosetting resin is a silicone resin.

4. The method according to claim 3, wherein the product part is a transparent optical device.

5. The method according to claim 1,
wherein the injecting process is performed by using the mold so that a first cross section of a connection portion between the cavity and the overflow catcher is within +/−10% of a second cross section of a connection portion between the cavity and the gate, and
the demolding process is performed to demold the resin molded article from the mold by striking a protrusion pin disposed to the mold on the runner part and the overflow part of the resin molded article.

6. The method according to claim 5, wherein the demolding process is performed to demold the resin molded article from the mold by striking the protrusion pin on the resin molded article while spraying a gas against the resin molded article for cooling.

7. The method according to claim 1,
wherein a cavity insert having a forming plane for forming a whole of the resin molded article in the mold is disposed, and the demolding process is performed to demold the resin molded article from the cavity insert by vibrating the cavity insert with an ultrasonic vibrator during a mold opening operation and/or after the mold opening.

8. The method according to claim 7, wherein the forming plane which is disposed to the cavity insert to form the whole of the resin molded article is constructed as a fixed plane which is not moved at least in the demolding process.

9. The method according to claim 7 or 8,
wherein the cavity insert is fitted into a mold plate through an elastic member, the elastic member also has a function as a sealing member for sustaining sealing of a resin molded article forming portion, and vacuum molding is performed in the injecting process.

10. The method according to claim 7 or 8, wherein the injecting process is performed by using the mold where a first cross section of a connection portion between the cavity and the overflow catcher is equal to or less than a second cross section of a connection portion between the cavity and the gate.

11. The method according to claim 10, wherein the injecting process is performed by using the mold where the first cross section is 0.2 times to 1.0 time of the second cross section.

12. The method according to claim 10, wherein the injecting process is performed by using the mold where the first cross section is 0.5 times to 1.0 time of the second cross section.

13. The method according to claim 7, wherein the demolding process is performed to demold the resin molded article from the cavity insert by vibrating the cavity insert with the ultrasonic vibrator while spraying a gas against the resin molded article for cooling, during a mold opening operation and/or after the mold opening.

14. An injection molding apparatus used for forming a molded article which is formed with a thermosetting resin through a liquid injection molding method, having
a mold comprising:
a cavity for molding a product part;
a gate which commutes with the cavity to guide a liquid thermosetting resin into the cavity, thereby forming a gate part;
a runner which commutes with the gate part to guide the liquid resin into the gate part, thereby forming a runner part; and
an overflow catcher which commutes with the cavity to receive the liquid resin overflown from the cavity, thereby forming an overflow part,
wherein a protrusion pin is disposed to be struck on the runner part and the overflow part so as to demold a resin molded article having the runner part, the gate part, the product part, and the overflow part from the mold,
a first cross section of a connection portion between the cavity and the overflow catcher is within +/−10% of a second cross section of a connection portion between the cavity and the gate.

15. An injection molding apparatus used for forming a molded article which is formed with a thermosetting resin through a liquid injection molding method, having
a mold comprising:
a cavity for molding a product part;
a gate which commutes with the cavity to guide a liquid thermosetting resin into the cavity, thereby forming a gate part;
a runner which commutes with the gate part to guide the liquid resin into the gate part, thereby forming a runner part; and
an overflow catcher which commutes with the cavity to receive the liquid resin overflown from the cavity, thereby forming an overflow part,
wherein a cavity insert having a forming plane for forming the whole of the resin molded article in the mold is disposed and an ultrasonic vibrator for vibrating the cavity insert is disposed, so as to demold a resin molded article having the runner part, the gate part, the product part, and the overflow part from the mold.

16. The injection molding apparatus according to claim 15, wherein the forming plane which is disposed to the cavity insert to form the whole of the resin molded article is constructed as a fixed plane which is not moved at least in the demolding process.

17. The injection molding apparatus according to claim 15 or 16,
wherein the cavity insert is fitted into a mold plate through an elastic member, and wherein the elastic member also has a function as a sealing member for sustaining sealing of a resin molded article forming portion when vacuum molding is performed in the injecting process.

18. The injection molding apparatus according to claim 15 or 16, wherein the cavity insert is provided with a flange portion so that position fixing is performed by interposing the flange portion.

19. The injection molding apparatus according to claim 18, wherein an interstice is provided to an outer circumference of the flange portion of the cavity insert.

20. The injection molding apparatus according to claim 15 or 16, wherein an injecting process is performed by using the mold where a first cross section of a connection portion between the cavity and the overflow catcher is equal to or less than a second cross section of a connection portion between the cavity and the gate.

21. The injection molding apparatus according to claim 20, wherein the injecting process is performed by using the mold where the first cross section is 0.2 times to 1.0 time of the second cross section.

22. The injection molding apparatus according to claim 20, wherein the injecting process is performed by using the mold where the first cross section is 0.5 times to 1.0 time of the second cross section.

23. The injection molding apparatus according to any one of claims 14 to 16, wherein gas spraying means for spraying a gas against the resin molded article during a mold opening operation and/or after the mold opening is disposed.

24. The injection molding apparatus according to claim 23,
wherein an extracting unit for extracting the resin molded article from the mold is further provided, and
the gas spraying means is disposed to an extracting chuck assembly of the extracting unit.
